(19) United States
(12) Patent Application Publication
(10) Pub. No.: US 2026/0270222 A1
(43) Pub. Date: Sep. 10, 2026

(54) Modifying Routing Configurations of a Network Fabric Based on Telemetry Data

(71) Applicant: Oracle International Corporation, Redwood Shores, CA (US)

(72) Inventors: Andrew B. Dickinson, Seattle, WA (US); Charles S. Gordon, Mountain View, CA (US)

(73) Assignee: Oracle International Corporation, Redwood Shores, CA (US)

(21) Appl. No.: 19/074,719

(22) Filed: Mar. 10, 2025

(51) Int. Cl. H04L 49/253; H04L 49/60

(52) U.S. Cl. CPC H04L 49/254; H04L 49/255; H04L 49/602

(57) ABSTRACT

A system obtains telemetry data associated with a fabric. The fabric includes a set of interconnected switches, organized according to a fabric topology, that provide multiple redundant pathways for routing data between a set of computing devices linked to the fabric. Based at least on the fabric topology, the system identifies a portion of the telemetry data corresponding to a first subsection of the fabric. Based at least on the fabric topology and the portion of the telemetry data, the system determines a performance metric corresponding to the first subsection of the fabric. Based at least on the performance metric, the system steers at least a portion of network traffic from the first subsection of the fabric to a second subsection of the fabric.

### TECHNICAL FIELD

The present disclosure relates to routing configurations for routing network traffic across network fabrics. More particularly, the present disclosure relates to modifying routing configurations of network fabrics based on telemetry data and steering network traffic across network fabrics based on telemetry data.

### BACKGROUND

A network fabric of a data center includes a set of interconnected switches and links that provide multiple redundant pathways for data flow between a set of computing devices. Network traffic is routed dynamically across the fabric, leveraging the redundant paths to balance load and maintain connectivity. Portions of the fabric, such as individual switches or groups of switches, may be out of service due to maintenance, outages, upgrades, or administrative configurations. Portions of the fabric that are out of service impact the overall performance of the fabric. For example, when a portion of the fabric is out of service, the capacity, utilization, headroom, and/or redundancy may be reduced, potentially increasing congestion and impacting the flow of network traffic across the fabric.

### BRIEF DESCRIPTION OF THE DRAWINGS

The embodiments are illustrated by way of example and not by way of limitation in the figures of the accompanying drawings. References to “an” or “one” embodiment in this disclosure are not necessarily to the same embodiment and refer to at least one embodiment. In the drawings:

FIG. 1 is a block diagram illustrating one pattern for implementing a cloud infrastructure as a service system, according to at least one embodiment;

FIG. 2 is a block diagram illustrating another pattern for implementing a cloud infrastructure as a service system, according to at least one embodiment;

FIG. 3 is a block diagram illustrating another pattern for implementing a cloud infrastructure as a service system, according to at least one embodiment;

FIG. 4 is a block diagram illustrating another pattern for implementing a cloud infrastructure as a service system, according to at least one embodiment;

FIG. 5 illustrates a block diagram that depicts features of an example system for executing operations pertaining to modifying routing configurations of a network fabric and/or steering network traffic across the network fabric in accordance with one or more embodiments;

FIG. 6 illustrates a block diagram that depicts example control system architecture for steering network traffic across a network fabric in accordance with one or more embodiments;

FIG. 7 is a flowchart that depict example operations pertaining to modifying routing configurations of a network fabric in accordance with one or more embodiments;

FIG. 8 is a flowchart that depict example operations pertaining to steering network traffic across a network fabric in accordance with one or more embodiments;

FIG. 9 is a high-level diagram of a distributed environment showing a virtual or overlay cloud network hosted by a cloud service provider infrastructure according to certain embodiments;

FIG. 10 depicts a simplified architectural diagram of the physical components in the physical network within CI according to certain embodiments;

FIG. 11 depicts a simplified block diagram of a physical network provided by a CI, according to certain embodiments;

FIG. 12 depicts a data center containing rows of compute racks and network racks, with the network racks implementing a network fabric, according to certain embodiments;

FIG. 13 illustrates features of an example machine learning system in accordance with one or more embodiments;

FIG. 14 is a flowchart that depicts example operations of a machine learning system in accordance with one or more embodiments; and

FIG. 15 illustrates a block diagram that depicts features of an example a hardware system in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.
1. GENERAL OVERVIEW
2. EXAMPLE CLOUD INFRASTRUCTURE
3. EXAMPLE FABRIC MANAGEMENT ARCHITECTURE
4. EXAMPLE OPERATIONS PERTAINING TO FABRIC MANAGEMENT
5. EXAMPLE CLOUD NETWORKS
6. EXAMPLE NETWORK FABRICS
7. EXAMPLE MACHINE LEARNING SYSTEM
8. HARDWARE SYSTEM
9. MISCELLANEOUS; EXTENSIONS

The term “cloud computing service” or “cloud service” generally refers to a service that is made available on demand, via scalable cloud infrastructure, typically over the internet or a private network, and managed by an external or in-house cloud provider (CP). The term “cloud infrastructure” (CI) generally refers to hardware and software components that provide computing, storage, and networking resources to deliver cloud services. There are various types or models of cloud services including Software-as-a-Service (SaaS), Platform-as-a-Service (PaaS), Infrastructure-as-a-Service (IaaS), Function-as-a-Service (FaaS), and others.

In a typical IaaS model, a CP provides virtualized and bare metal computing resources like servers, storage, and networking in a CP-operated data center. The CP is responsible for managing and maintaining the CI; the responsibilities span across multiple domains, such as operations, security, scalability, and compliance. Customers access the cloud services over the public Internet. Customers can use the CP CI to build their own customizable virtual or overlay networks and deploy customer resources. In other models, a CP provides similar virtualized and bare metal computing resources but in a customer-operated data center, which may include the customer's own CI. Customers access the CP CI and the customer CI over a private network. The combination of cloud services of the CP and the customer may be referred to as a “hybrid cloud.” In some cases, customers can serve as the CP's partner and sell the CP cloud services to further downstream customers. In yet other models, a first CP provides its virtualized and bare metal computing resources like servers, storage, and networking in the first CP's data center. A second CP provides its virtualized and bare metal computing resources also in the first CP's data center. A dedicated private network connects the CI of the two CPs. The combination of cloud services of the both CPs may be referred to as a “hybrid cloud.” In yet other models, a CP initially provisions CI to a customer, and then hands over all or a subset of the responsibilities associated with managing and maintaining the CI. For example, the customer may be primarily responsible for duties such as provisioning, repair, and maintenance of compute instances, while the CP retains other duties such as network management. Still other models may be used.

### 1. General Overview

One or more embodiments determine whether to implement proposed modifications to routing configurations of a fabric based on performance metrics corresponding to the proposed modifications. A system determines a performance metric corresponding to the proposed modification based on (a) fabric topology of the fabric and (b) telemetry data associated with the fabric. The system determines whether the performance metric satisfies an acceptability criterion for proceeding with implementing the proposed modification. In response to determining that the acceptability criterion is satisfied, the system proceeds with implementing the proposed modification. Additionally, or alternatively, in response to determining that the performance metric does not satisfy the acceptability criterion, the system refrains from implementing the proposed modification. The performance metric may represent an effect that the proposed modification has on the performance of the fabric such as an effect on the capacity, headroom, and/or utilization of the fabric. By considering performance metrics corresponding to proposed modifications, the system ensures that acceptability criteria are satisfied before proceeding with the proposed modifications.

Additionally, or alternatively, one or more embodiments steer network traffic to particular subsections of a fabric based on performance metrics corresponding to the particular subsections of the fabric. The system identifies a portion of telemetry data corresponding to a subsection of the fabric based at least on a fabric topology of the fabric. Based at least on the fabric topology and the portion of the telemetry data, the system determines a performance metric corresponding to the subsection of the fabric, and based at least on the performance metric, the system steers at least a portion of network traffic towards or away from the subsection of the fabric. By steering network traffic to portions of the fabric based on performance metrics, the system can proactively manage the capacity, headroom, and/or utilization of the fabric.

### 2. Example Cloud Infrastructure

As noted above, infrastructure as a service (IaaS) is one particular type of cloud computing. For IaaS, the infrastructure (CI) provided by a CP can be configured to provide virtualized computing resources over a public network (e.g., the Internet). In an IaaS model, a CP can host the infrastructure components (e.g., servers, storage devices, network nodes (e.g., hardware), deployment software, platform virtualization (e.g., a hypervisor layer), or the like). CI thus provides infrastructure and a set of complementary cloud services that enable customers to build and run a wide range of applications and services in a highly available hosted distributed environment. The customer does not manage or control the underlying physical resources provided by CI but has control over operating systems, storage, and deployed applications; and possibly limited control of select networking components (e.g., firewalls).

In some cases, an IaaS provider may also supply a variety of services to accompany those infrastructure components (example services include billing software, monitoring software, logging software, load balancing software, clustering software, etc.). Thus, as these services may be policy-driven, IaaS users may be able to implement policies to drive load balancing to maintain application availability and performance. When a customer subscribes to or registers for an IaaS service provided by a CP, a tenancy, or account, is created for the customer. A tenancy is a secure and isolated partition within the CI where the customer can create, organize, and administer their cloud resources.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

The CP may provide a console that enables customers and network administrators to configure, access, and manage resources deployed in the cloud using CI resources. In certain embodiments, the console provides a web-based user interface that can be used to access and manage CI. In some implementations, the console is a web-based application provided by the CP.

CI may support single-tenancy or multi-tenancy architectures. In a single tenancy architecture, a software (e.g., an application, a database) or a hardware component (e.g., a host machine or a server) of the CI serves a single customer or tenant. In a multi-tenancy architecture, a software or a hardware component of the CI serves multiple customers or tenants. Thus, in a multi-tenancy architecture, CI resources are shared between multiple customers or tenants. In a multi-tenancy situation, precautions are taken, and safeguards put in place within CI to ensure that each tenant's data is isolated and remains invisible to other tenants.

In certain embodiments, each resource within CI is assigned a unique identifier called a Cloud Identifier (CID). This identifier is included as part of the resource's information and can be used to manage the resource, for example, via a Console or through APIs. An example syntax for a CID is: cid1.<RESOURCE TYPE>.<REALM>.[REGION][.FUTURE USE].<UNIQUE ID> where, cid1: The literal string indicating the version of the CID; resource type: The type of resource (for example, instance, volume, VCN, subnet, user, group, and so on); realm: The realm the resource is in. Example values are “c1” for the commercial realm, “c2” for the Government Cloud realm, or “c3” for the Federal Government Cloud realm, etc. Each realm may have its own domain name; region: The region the resource is in. If the region is not applicable to the resource, this part might be blank; future use: Reserved for future use. unique ID: The unique portion of the ID. The format may vary depending on the type of resource or service.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

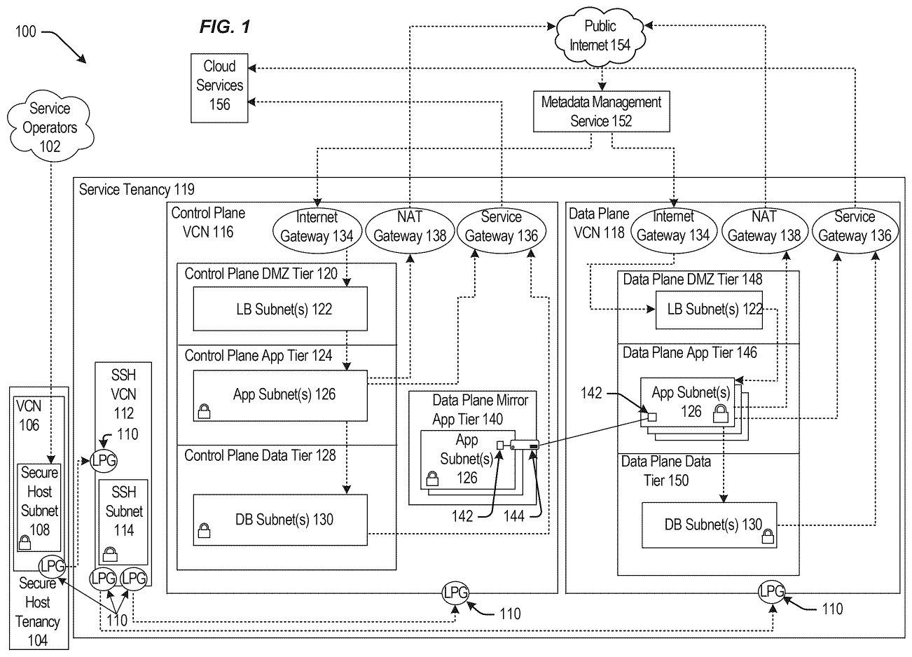

FIG. 1 is a block diagram 100 illustrating an example pattern of an IaaS architecture, according to at least one embodiment. Service operators 102 can be communicatively coupled to a secure host tenancy 104 that can include a virtual cloud network (VCN) 106 and a secure host subnet 108. In some examples, the service operators 102 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 106 and/or the Internet.

The VCN 106 can include a local peering gateway (LPG) 110 that can be communicatively coupled to a secure shell (SSH) VCN 112 via an LPG 110 contained in the SSH VCN 112. The SSH VCN 112 can include an SSH subnet 114, and the SSH VCN 112 can be communicatively coupled to a control plane VCN 116 via the LPG 110 contained in the control plane VCN 116. Also, the SSH VCN 112 can be communicatively coupled to a data plane VCN 118 via an LPG 110. The control plane VCN 116 and the data plane VCN 118 can be contained in a service tenancy 119 that can be owned and/or operated by the IaaS provider.

The control plane VCN 116 can include a control plane demilitarized zone (DMZ) tier 120 that acts as a perimeter network (e.g., portions of a corporate network between the corporate intranet and external networks). The DMZ-based servers may have restricted responsibilities and help keep breaches contained. Additionally, the DMZ tier 120 can include one or more load balancer (LB) subnet(s) 122, a control plane app tier 124 that can include app subnet(s) 126, a control plane data tier 128 that can include database (DB) subnet(s) 130 (e.g., frontend DB subnet(s) and/or backend DB subnet(s)). The LB subnet(s) 122 contained in the control plane DMZ tier 120 can be communicatively coupled to the app subnet(s) 126 contained in the control plane app tier 124 and an Internet gateway 134 that can be contained in the control plane VCN 116, and the app subnet(s) 126 can be communicatively coupled to the DB subnet(s) 130 contained in the control plane data tier 128 and a service gateway 136 and a network address translation (NAT) gateway 138. The control plane VCN 116 can include the service gateway 136 and the NAT gateway 138.

The control plane VCN 116 can include a data plane mirror app tier 140 that can include app subnet(s) 126. The app subnet(s) 126 contained in the data plane mirror app tier 140 can include a virtual network interface controller (VNIC) 142 that can execute a compute instance 144. The compute instance 144 can communicatively couple the app subnet(s) 126 of the data plane mirror app tier 140 to app subnet(s) 126 that can be contained in a data plane app tier 146.

The data plane VCN 118 can include the data plane app tier 146, a data plane DMZ tier 148, and a data plane data tier 150. The data plane DMZ tier 148 can include LB subnet(s) 122 that can be communicatively coupled to the app subnet(s) 126 of the data plane app tier 146 and the Internet gateway 134 of the data plane VCN 118. The app subnet(s) 126 can be communicatively coupled to the service gateway 136 of the data plane VCN 118 and the NAT gateway 138 of the data plane VCN 118. The data plane data tier 150 can also include the DB subnet(s) 130 that can be communicatively coupled to the app subnet(s) 126 of the data plane app tier 146.

The Internet gateway 134 of the control plane VCN 116 and of the data plane VCN 118 can be communicatively coupled to a metadata management service 152 that can be communicatively coupled to public Internet 154. Public Internet 154 can be communicatively coupled to the NAT gateway 138 of the control plane VCN 116 and of the data plane VCN 118. The service gateway 136 of the control plane VCN 116 and of the data plane VCN 118 can be communicatively couple to cloud services 156.

In some examples, the service gateway 136 of the control plane VCN 116 or of the data plane VCN 118 can make application programming interface (API) calls to cloud services 156 without going through public Internet 154. The API calls to cloud services 156 from the service gateway 136 can be one-way: the service gateway 136 can make API calls to cloud services 156, and cloud services 156 can send requested data to the service gateway 136. But, cloud services 156 may not initiate API calls to the service gateway 136.

In some examples, the secure host tenancy 104 can be directly connected to the service tenancy 119, which may be otherwise isolated. The secure host subnet 108 can communicate with the SSH subnet 114 through an LPG 110 that may enable two-way communication over an otherwise isolated system. Connecting the secure host subnet 108 to the SSH subnet 114 may give the secure host subnet 108 access to other entities within the service tenancy 119.

The control plane VCN 116 may allow users of the service tenancy 119 to set up or otherwise provision desired resources. Desired resources provisioned in the control plane VCN 116 may be deployed or otherwise used in the data plane VCN 118. In some examples, the control plane VCN 116 can be isolated from the data plane VCN 118, and the data plane mirror app tier 140 of the control plane VCN 116 can communicate with the data plane app tier 146 of the data plane VCN 118 via VNICs 142 that can be contained in the data plane mirror app tier 140 and the data plane app tier 146.

In some examples, users of the system, or customers, can make requests, for example create, read, update, or delete (CRUD) operations, through public Internet 154 that can communicate the requests to the metadata management service 152. The metadata management service 152 can communicate the request to the control plane VCN 116 through the Internet gateway 134. The request can be received by the LB subnet(s) 122 contained in the control plane DMZ tier 120. The LB subnet(s) 122 may determine that the request is valid, and in response to this determination, the LB subnet(s) 122 can transmit the request to app subnet(s) 126 contained in the control plane app tier 124. If the request is validated and requires a call to public Internet 154, the call to public Internet 154 may be transmitted to the NAT gateway 138 that can make the call to public Internet 154. Metadata that may be desired to be stored by the request can be stored in the DB subnet(s) 130.

In some examples, the data plane mirror app tier 140 can facilitate direct communication between the control plane VCN 116 and the data plane VCN 118. For example, changes, updates, or other suitable modifications to configuration may be desired to be applied to the resources contained in the data plane VCN 118. Via a VNIC 142, the control plane VCN 116 can directly communicate with, and can thereby execute the changes, updates, or other suitable modifications to configuration to, resources contained in the data plane VCN 118.

In some embodiments, the control plane VCN 116 and the data plane VCN 118 can be contained in the service tenancy 119. In this case, the user, or the customer, of the system may not own or operate either the control plane VCN 116 or the data plane VCN 118. Instead, the IaaS provider may own or operate the control plane VCN 116 and the data plane VCN 118, both of which may be contained in the service tenancy 119. This embodiment can enable isolation of networks that may prevent users or customers from interacting with other users', or other customers', resources. Also, this embodiment may allow users or customers of the system to store databases privately without needing to rely on public Internet 154, which may not have a desired level of threat prevention, for storage.

In other embodiments, the LB subnet(s) 122 contained in the control plane VCN 116 can be configured to receive a signal from the service gateway 136. In this embodiment, the control plane VCN 116 and the data plane VCN 118 may be configured to be called by a customer of the IaaS provider without calling public Internet 154. Customers of the IaaS provider may desire this embodiment since database(s) that the customers use may be controlled by the IaaS provider and may be stored on the service tenancy 119, which may be isolated from public Internet 154.

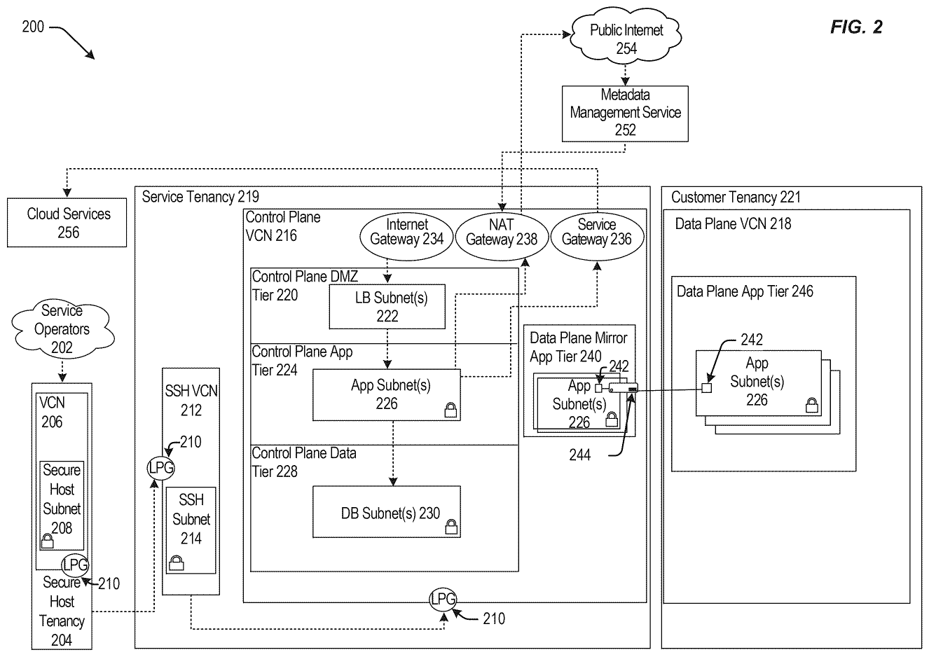

FIG. 2 is a block diagram 200 illustrating another example pattern of an IaaS architecture, according to at least one embodiment. Service operators 202 (e.g., service operators 102 of FIG. 1) can be communicatively coupled to a secure host tenancy 204 (e.g., the secure host tenancy 104 of FIG. 1) that can include a virtual cloud network (VCN) 206 (e.g., the VCN 106 of FIG. 1) and a secure host subnet 208 (e.g., the secure host subnet 108 of FIG. 1). The VCN 206 can include a local peering gateway (LPG) 210 (e.g., the LPG 110 of FIG. 1) that can be communicatively coupled to a secure shell (SSH) VCN 212 (e.g., the SSH VCN 112 of FIG. 1) via an LPG 110 contained in the SSH VCN 212. The SSH VCN 212 can include an SSH subnet 214 (e.g., the SSH subnet 114 of FIG. 1), and the SSH VCN 212 can be communicatively coupled to a control plane VCN 216 (e.g., the control plane VCN 116 of FIG. 1) via an LPG 210 contained in the control plane VCN 216. The control plane VCN 216 can be contained in a service tenancy 219 (e.g., the service tenancy 119 of FIG. 1), and the data plane VCN 218 (e.g., the data plane VCN 118 of FIG. 1) can be contained in a customer tenancy 221 that may be owned or operated by users, or customers, of the system.

The control plane VCN 216 can include a control plane DMZ tier 220 (e.g., the control plane DMZ tier 120 of FIG. 1) that can include LB subnet(s) 222 (e.g., LB subnet(s) 122 of FIG. 1), a control plane app tier 224 (e.g., the control plane app tier 124 of FIG. 1) that can include app subnet(s) 226 (e.g., app subnet(s) 126 of FIG. 1), a control plane data tier 228 (e.g., the control plane data tier 128 of FIG. 1) that can include database (DB) subnet(s) 230 (e.g., similar to DB subnet(s) 130 of FIG. 1). The LB subnet(s) 222 contained in the control plane DMZ tier 220 can be communicatively coupled to the app subnet(s) 226 contained in the control plane app tier 224 and an Internet gateway 234 (e.g., the Internet gateway 134 of FIG. 1) that can be contained in the control plane VCN 216, and the app subnet(s) 226 can be communicatively coupled to the DB subnet(s) 230 contained in the control plane data tier 228 and a service gateway 236 (e.g., the service gateway 136 of FIG. 1) and a network address translation (NAT) gateway 238 (e.g., the NAT gateway 138 of FIG. 1). The control plane VCN 216 can include the service gateway 236 and the NAT gateway 238.

The control plane VCN 216 can include a data plane mirror app tier 240 (e.g., the data plane mirror app tier 140 of FIG. 1) that can include app subnet(s) 226. The app subnet(s) 226 contained in the data plane mirror app tier 240 can include a virtual network interface controller (VNIC) 242 (e.g., the VNIC of 142) that can execute a compute instance 244 (e.g., similar to the compute instance 144 of FIG. 1). The compute instance 244 can facilitate communication between the app subnet(s) 226 of the data plane mirror app tier 240 and the app subnet(s) 226 that can be contained in a data plane app tier 246 (e.g., the data plane app tier 146 of FIG. 1) via the VNIC 242 contained in the data plane mirror app tier 240 and the VNIC 242 contained in the data plane app tier 246.

The Internet gateway 234 contained in the control plane VCN 216 can be communicatively coupled to a metadata management service 252 (e.g., the metadata management service 152 of FIG. 1) that can be communicatively coupled to public Internet 254 (e.g., public Internet 154 of FIG. 1). Public Internet 254 can be communicatively coupled to the NAT gateway 238 contained in the control plane VCN 216. The service gateway 236 contained in the control plane VCN 216 can be communicatively couple to cloud services 256 (e.g., cloud services 156 of FIG. 1).

In some examples, the data plane VCN 218 can be contained in the customer tenancy 221. In this case, the IaaS provider may provide the control plane VCN 216 for each customer, and the IaaS provider may, for each customer, set up a unique compute instance 244 that is contained in the service tenancy 219. Each compute instance 244 may allow communication between the control plane VCN 216, contained in the service tenancy 219, and the data plane VCN 218 that is contained in the customer tenancy 221. The compute instance 244 may allow resources, that are provisioned in the control plane VCN 216 that is contained in the service tenancy 219, to be deployed or otherwise used in the data plane VCN 218 that is contained in the customer tenancy 221.

In other examples, the customer of the IaaS provider may have databases that live in the customer tenancy 221. In this example, the control plane VCN 216 can include the data plane mirror app tier 240 that can include app subnet(s) 226. The data plane mirror app tier 240 can reside in the data plane VCN 218, but the data plane mirror app tier 240 may not live in the data plane VCN 218. That is, the data plane mirror app tier 240 may have access to the customer tenancy 221, but the data plane mirror app tier 240 may not exist in the data plane VCN 218 or be owned or operated by the customer of the IaaS provider. The data plane mirror app tier 240 may be configured to make calls to the data plane VCN 218 but may not be configured to make calls to any entity contained in the control plane VCN 216. The customer may desire to deploy or otherwise use resources in the data plane VCN 218 that are provisioned in the control plane VCN 216, and the data plane mirror app tier 240 can facilitate the desired deployment, or other usage of resources, of the customer.

In some embodiments, the customer of the IaaS provider can apply filters to the data plane VCN 218. In this embodiment, the customer can determine what the data plane VCN 218 can access, and the customer may restrict access to public Internet 254 from the data plane VCN 218. The IaaS provider may not be able to apply filters or otherwise control access of the data plane VCN 218 to any outside networks or databases. Applying filters and controls by the customer onto the data plane VCN 218, contained in the customer tenancy 221, can help isolate the data plane VCN 218 from other customers and from public Internet 254.

In some embodiments, cloud services 256 can be called by the service gateway 236 to access services that may not exist on public Internet 254, on the control plane VCN 216, or on the data plane VCN 218. The connection between cloud services 256 and the control plane VCN 216 or the data plane VCN 218 may not be live or continuous. Cloud services 256 may exist on a different network owned or operated by the IaaS provider. Cloud services 256 may be configured to receive calls from the service gateway 236 and may be configured to not receive calls from public Internet 254. Some cloud services 256 may be isolated from other cloud services 256, and the control plane VCN 216 may be isolated from cloud services 256 that may not be in the same region as the control plane VCN 216. For example, the control plane VCN 216 may be located in “Region 1,” and cloud service “Deployment 1,” may be located in Region 1 and in “Region 2.” If a call to Deployment 1 is made by the service gateway 236 contained in the control plane VCN 216 located in Region 1, the call may be transmitted to Deployment 1 in Region 1. In this example, the control plane VCN 216, or Deployment 1 in Region 1, may not be communicatively coupled to, or otherwise in communication with, Deployment 1 in Region 2.

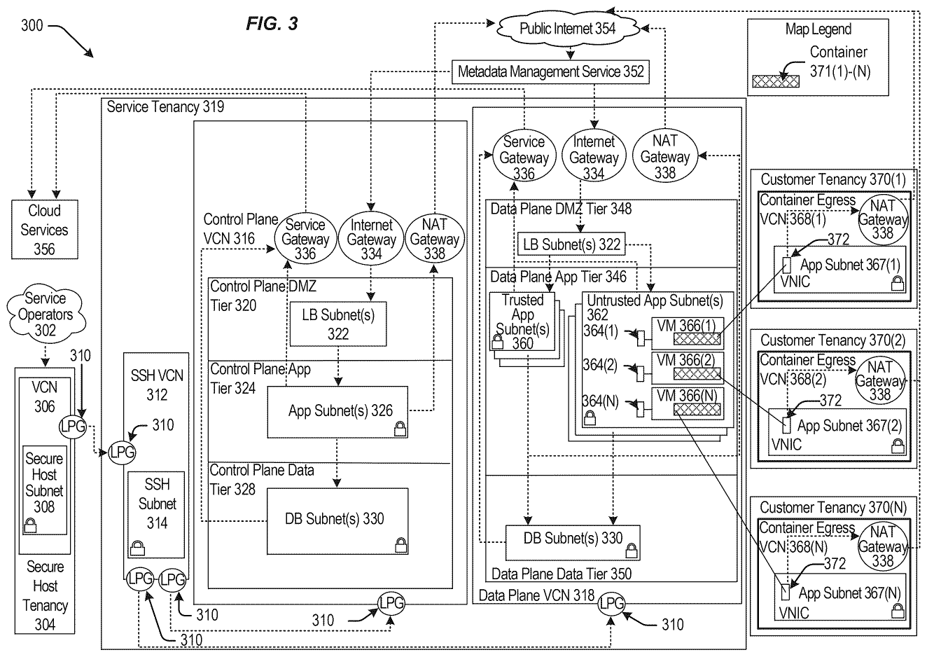

FIG. 3 is a block diagram 300 illustrating another example pattern of an IaaS architecture, according to at least one embodiment. Service operators 302 (e.g., service operators 102 of FIG. 1) can be communicatively coupled to a secure host tenancy 304 (e.g., the secure host tenancy 104 of FIG. 1) that can include a virtual cloud network (VCN) 306 (e.g., the VCN 106 of FIG. 1) and a secure host subnet 308 (e.g., the secure host subnet 108 of FIG. 1). The VCN 306 can include an LPG 310 (e.g., the LPG 110 of FIG. 1) that can be communicatively coupled to an SSH VCN 312 (e.g., the SSH VCN 112 of FIG. 1) via an LPG 310 contained in the SSH VCN 312. The SSH VCN 312 can include an SSH subnet 314 (e.g., the SSH subnet 114 of FIG. 1), and the SSH VCN 312 can be communicatively coupled to a control plane VCN 316 (e.g., the control plane VCN 116 of FIG. 1) via an LPG 310 contained in the control plane VCN 316 and to a data plane VCN 318 (e.g., the data plane 118 of FIG. 1) via an LPG 310 contained in the data plane VCN 318. The control plane VCN 316 and the data plane VCN 318 can be contained in a service tenancy 319 (e.g., the service tenancy 119 of FIG. 1).

The control plane VCN 316 can include a control plane DMZ tier 320 (e.g., the control plane DMZ tier 120 of FIG. 1) that can include load balancer (LB) subnet(s) 322 (e.g., LB subnet(s) 122 of FIG. 1), a control plane app tier 324 (e.g., the control plane app tier 124 of FIG. 1) that can include app subnet(s) 326 (e.g., similar to app subnet(s) 126 of FIG. 1), a control plane data tier 328 (e.g., the control plane data tier 128 of FIG. 1) that can include DB subnet(s) 330. The LB subnet(s) 322 contained in the control plane DMZ tier 320 can be communicatively coupled to the app subnet(s) 326 contained in the control plane app tier 324 and to an Internet gateway 334 (e.g., the Internet gateway 134 of FIG. 1) that can be contained in the control plane VCN 316, and the app subnet(s) 326 can be communicatively coupled to the DB subnet(s) 330 contained in the control plane data tier 328 and to a service gateway 336 (e.g., the service gateway of FIG. 1) and a network address translation (NAT) gateway 338 (e.g., the NAT gateway 138 of FIG. 1). The control plane VCN 316 can include the service gateway 336 and the NAT gateway 338.

The data plane VCN 318 can include a data plane app tier 346 (e.g., the data plane app tier 146 of FIG. 1), a data plane DMZ tier 348 (e.g., the data plane DMZ tier 148 of FIG. 1), and a data plane data tier 350 (e.g., the data plane data tier 150 of FIG. 1). The data plane DMZ tier 348 can include LB subnet(s) 322 that can be communicatively coupled to trusted app subnet(s) 360 and untrusted app subnet(s) 362 of the data plane app tier 346 and the Internet gateway 334 contained in the data plane VCN 318. The trusted app subnet(s) 360 can be communicatively coupled to the service gateway 336 contained in the data plane VCN 318, the NAT gateway 338 contained in the data plane VCN 318, and DB subnet(s) 330 contained in the data plane data tier 350. The untrusted app subnet(s) 362 can be communicatively coupled to the service gateway 336 contained in the data plane VCN 318 and DB subnet(s) 330 contained in the data plane data tier 350. The data plane data tier 350 can include DB subnet(s) 330 that can be communicatively coupled to the service gateway 336 contained in the data plane VCN 318.

The untrusted app subnet(s) 362 can include one or more primary VNICs 364(1)-(N) that can be communicatively coupled to tenant virtual machines (VMs) 366(1)-(N). Each tenant VM 366(1)-(N) can be communicatively coupled to a respective app subnet 367(1)-(N) that can be contained in respective container egress VCNs 368(1)-(N) that can be contained in respective customer tenancies 370(1)-(N). Respective secondary VNICs 372(1)-(N) can facilitate communication between the untrusted app subnet(s) 362 contained in the data plane VCN 318 and the app subnet contained in the container egress VCNs 368(1)-(N). Each container egress VCNs 368(1)-(N) can include a NAT gateway 338 that can be communicatively coupled to public Internet 354 (e.g., public Internet 154 of FIG. 1).

The Internet gateway 334 contained in the control plane VCN 316 and contained in the data plane VCN 318 can be communicatively coupled to a metadata management service 352 (e.g., the metadata management system 152 of FIG. 1) that can be communicatively coupled to public Internet 354. Public Internet 354 can be communicatively coupled to the NAT gateway 338 contained in the control plane VCN 316 and contained in the data plane VCN 318. The service gateway 336 contained in the control plane VCN 316 and contained in the data plane VCN 318 can be communicatively couple to cloud services 356.

In some embodiments, the data plane VCN 318 can be integrated with customer tenancies 370. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane app tier 346. Code to run the function may be executed in the VMs 366(1)-(N), and the code may not be configured to run anywhere else on the data plane VCN 318. Each VM 366(1)-(N) may be connected to one customer tenancy 370. Respective containers 371(1)-(N) contained in the VMs 366(1)-(N) may be configured to run the code. In this case, there can be a dual isolation (e.g., the containers 371(1)-(N) running code, where the containers 371(1)-(N) may be contained in at least the VM 366(1)-(N) that are contained in the untrusted app subnet(s) 362), which may help prevent incorrect or otherwise undesirable code from damaging the network of the IaaS provider or from damaging a network of a different customer. The containers 371(1)-(N) may be communicatively coupled to the customer tenancy 370 and may be configured to transmit or receive data from the customer tenancy 370. The containers 371(1)-(N) may not be configured to transmit or receive data from any other entity in the data plane VCN 318. Upon completion of running the code, the IaaS provider may kill or otherwise dispose of the containers 371(1)-(N).

In some embodiments, the trusted app subnet(s) 360 may run code that may be owned or operated by the IaaS provider. In this embodiment, the trusted app subnet(s) 360 may be communicatively coupled to the DB subnet(s) 330 and be configured to execute CRUD operations in the DB subnet(s) 330. The untrusted app subnet(s) 362 may be communicatively coupled to the DB subnet(s) 330, but in this embodiment, the untrusted app subnet(s) may be configured to execute read operations in the DB subnet(s) 330. The containers 371(1)-(N) that can be contained in the VM 366(1)-(N) of each customer and that may run code from the customer may not be communicatively coupled with the DB subnet(s) 330.

In other embodiments, the control plane VCN 316 and the data plane VCN 318 may not be directly communicatively coupled. In this embodiment, there may be no direct communication between the control plane VCN 316 and the data plane VCN 318. However, communication can occur indirectly through at least one method. An LPG 310 may be established by the IaaS provider that can facilitate communication between the control plane VCN 316 and the data plane VCN 318. In another example, the control plane VCN 316 or the data plane VCN 318 can make a call to cloud services 356 via the service gateway 336. For example, a call to cloud services 356 from the control plane VCN 316 can include a request for a service that can communicate with the data plane VCN 318.

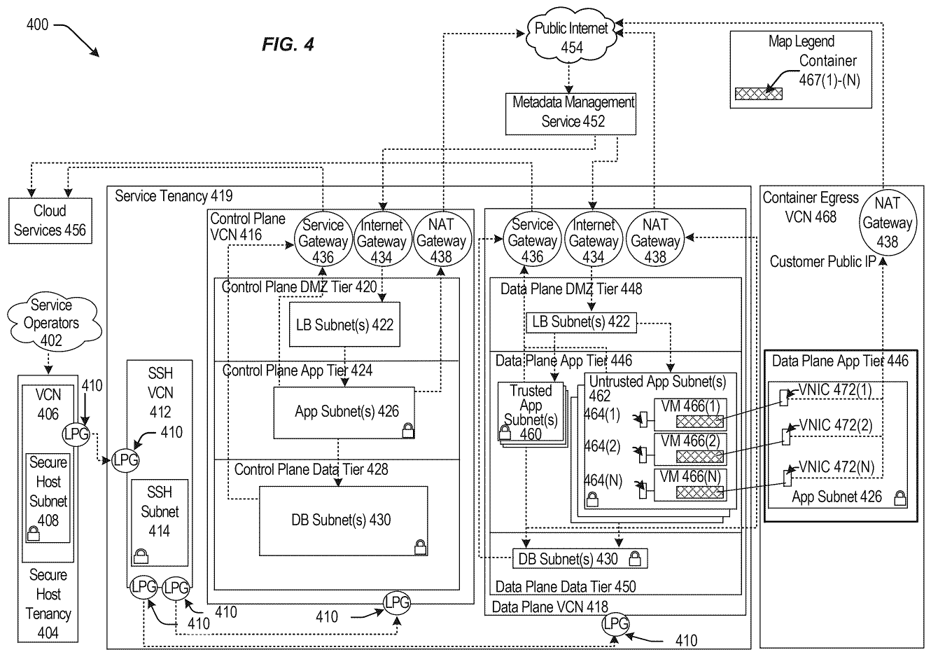

FIG. 4 is a block diagram 400 illustrating another example pattern of an IaaS architecture, according to at least one embodiment. Service operators 402 (e.g., service operators 102 of FIG. 1) can be communicatively coupled to a secure host tenancy 404 (e.g., the secure host tenancy 104 of FIG. 1) that can include a virtual cloud network (VCN) 406 (e.g., the VCN 106 of FIG. 1) and a secure host subnet 408 (e.g., the secure host subnet 108 of FIG. 1). The VCN 406 can include an LPG 410 (e.g., the LPG 110 of FIG. 1) that can be communicatively coupled to an SSH VCN 412 (e.g., the SSH VCN 112 of FIG. 1) via an LPG 410 contained in the SSH VCN 412. The SSH VCN 412 can include an SSH subnet 414 (e.g., the SSH subnet 114 of FIG. 1), and the SSH VCN 412 can be communicatively coupled to a control plane VCN 416 (e.g., the control plane VCN 116 of FIG. 1) via an LPG 410 contained in the control plane VCN 416 and to a data plane VCN 418 (e.g., the data plane 118 of FIG. 1) via an LPG 410 contained in the data plane VCN 418. The control plane VCN 416 and the data plane VCN 418 can be contained in a service tenancy 419 (e.g., the service tenancy 119 of FIG. 1).

The control plane VCN 416 can include a control plane DMZ tier 420 (e.g., the control plane DMZ tier 120 of FIG. 1) that can include LB subnet(s) 422 (e.g., LB subnet(s) 122 of FIG. 1), a control plane app tier 424 (e.g., the control plane app tier 124 of FIG. 1) that can include app subnet(s) 426 (e.g., app subnet(s) 126 of FIG. 1), a control plane data tier 428 (e.g., the control plane data tier 128 of FIG. 1) that can include DB subnet(s) 430 (e.g., DB subnet(s) 330 of FIG. 3). The LB subnet(s) 422 contained in the control plane DMZ tier 420 can be communicatively coupled to the app subnet(s) 426 contained in the control plane app tier 424 and to an Internet gateway 434 (e.g., the Internet gateway 134 of FIG. 1) that can be contained in the control plane VCN 416, and the app subnet(s) 426 can be communicatively coupled to the DB subnet(s) 430 contained in the control plane data tier 428 and to a service gateway 436 (e.g., the service gateway of FIG. 1) and a network address translation (NAT) gateway 438 (e.g., the NAT gateway 138 of FIG. 1). The control plane VCN 416 can include the service gateway 436 and the NAT gateway 438.

The data plane VCN 418 can include a data plane app tier 446 (e.g., the data plane app tier 146 of FIG. 1), a data plane DMZ tier 448 (e.g., the data plane DMZ tier 148 of FIG. 1), and a data plane data tier 450 (e.g., the data plane data tier 150 of FIG. 1). The data plane DMZ tier 448 can include LB subnet(s) 422 that can be communicatively coupled to trusted app subnet(s) 460 (e.g., trusted app subnet(s) 360 of FIG. 3) and untrusted app subnet(s) 462 (e.g., untrusted app subnet(s) 362 of FIG. 3) of the data plane app tier 446 and the Internet gateway 434 contained in the data plane VCN 418. The trusted app subnet(s) 460 can be communicatively coupled to the service gateway 436 contained in the data plane VCN 418, the NAT gateway 438 contained in the data plane VCN 418, and DB subnet(s) 430 contained in the data plane data tier 450. The untrusted app subnet(s) 462 can be communicatively coupled to the service gateway 436 contained in the data plane VCN 418 and DB subnet(s) 430 contained in the data plane data tier 450. The data plane data tier 450 can include DB subnet(s) 430 that can be communicatively coupled to the service gateway 436 contained in the data plane VCN 418.

The untrusted app subnet(s) 462 can include primary VNICs 464(1)-(N) that can be communicatively coupled to tenant virtual machines (VMs) 466(1)-(N) residing within the untrusted app subnet(s) 462. Each tenant VM 466(1)-(N) can run code in a respective container 467(1)-(N), and be communicatively coupled to an app subnet 426 that can be contained in a data plane app tier 446 that can be contained in a container egress VCN 468. Respective secondary VNICs 472(1)-(N) can facilitate communication between the untrusted app subnet(s) 462 contained in the data plane VCN 418 and the app subnet contained in the container egress VCN 468. The container egress VCN can include a NAT gateway 438 that can be communicatively coupled to public Internet 454 (e.g., public Internet 154 of FIG. 1).

The Internet gateway 434 contained in the control plane VCN 416 and contained in the data plane VCN 418 can be communicatively coupled to a metadata management service 452 (e.g., the metadata management system 152 of FIG. 1) that can be communicatively coupled to public Internet 454. Public Internet 454 can be communicatively coupled to the NAT gateway 438 contained in the control plane VCN 416 and contained in the data plane VCN 418. The service gateway 436 contained in the control plane VCN 416 and contained in the data plane VCN 418 can be communicatively couple to cloud services 456.

In some examples, the pattern illustrated by the architecture of block diagram 400 of FIG. 4 may be considered an exception to the pattern illustrated by the architecture of block diagram 300 of FIG. 3 and may be desirable for a customer of the IaaS provider if the IaaS provider cannot directly communicate with the customer (e.g., a disconnected region). The respective containers 467(1)-(N) that are contained in the VMs 466(1)-(N) for each customer can be accessed in real-time by the customer. The containers 467(1)-(N) may be configured to make calls to respective secondary VNICs 472(1)-(N) contained in app subnet(s) 426 of the data plane app tier 446 that can be contained in the container egress VCN 468. The secondary VNICs 472(1)-(N) can transmit the calls to the NAT gateway 438 that may transmit the calls to public Internet 454. In this example, the containers 467(1)-(N) that can be accessed in real-time by the customer can be isolated from the control plane VCN 416 and can be isolated from other entities contained in the data plane VCN 418. The containers 467(1)-(N) may also be isolated from resources from other customers.

In other examples, the customer can use the containers 467(1)-(N) to call cloud services 456. In this example, the customer may run code in the containers 467(1)-(N) that requests a service from cloud services 456. The containers 467(1)-(N) can transmit this request to the secondary VNICs 472(1)-(N) that can transmit the request to the NAT gateway that can transmit the request to public Internet 454. Public Internet 454 can transmit the request to LB subnet(s) 422 contained in the control plane VCN 416 via the Internet gateway 434. In response to determining the request is valid, the LB subnet(s) can transmit the request to app subnet(s) 426 that can transmit the request to cloud services 456 via the service gateway 436.

It should be appreciated that IaaS architectures 100, 200, 300, 400 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

### 3. Example Fabric Management Architecture

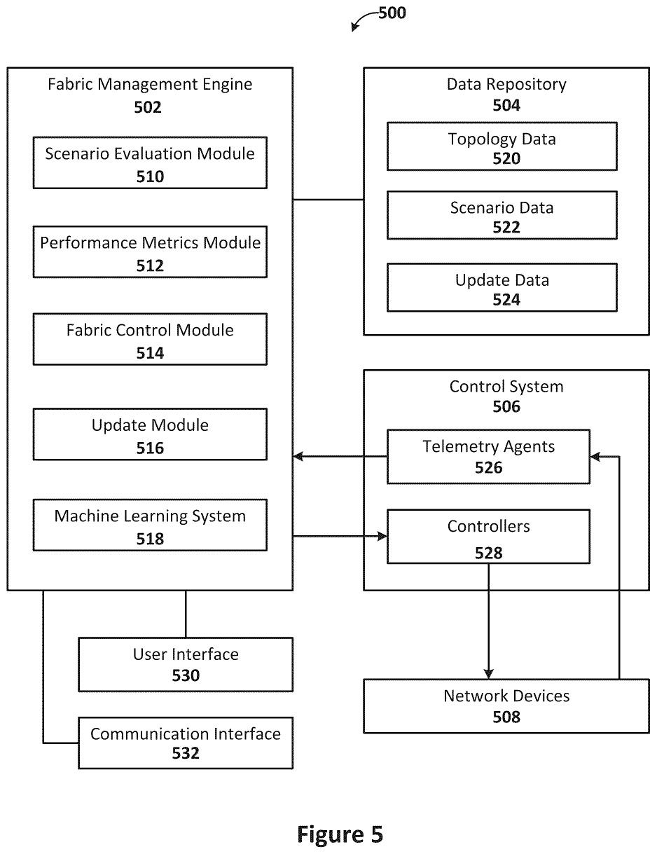

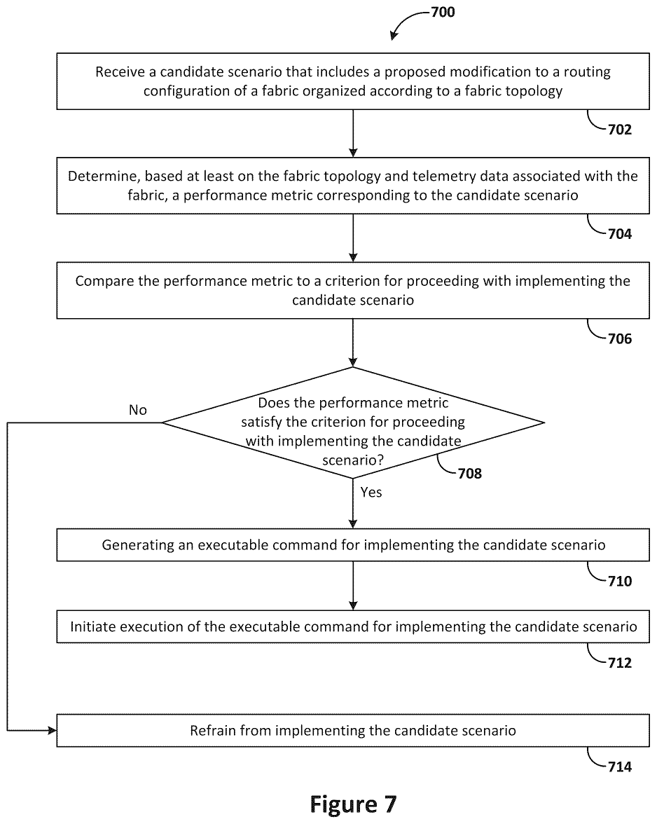

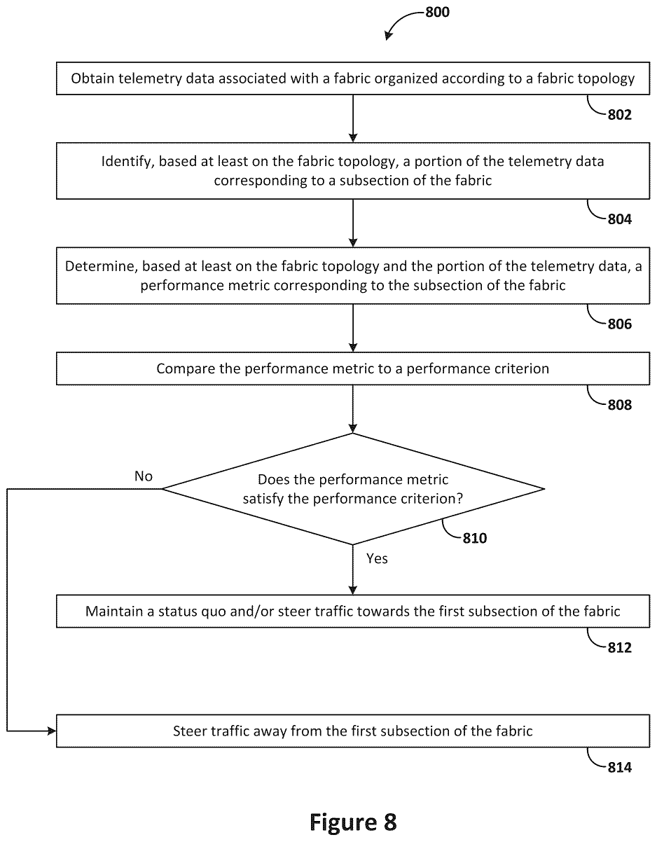

FIG. 5 illustrates features of an example system 500 for executing operations pertaining to modifying routing configurations of a network fabric and/or steering network traffic across the network fabric. In one or more embodiments, the system 500 refers to hardware and/or software configured to perform operations described herein. Examples of operations are described below with reference to FIGS. 7 and 8. In one example, the system described with reference to FIG. 5 may include one or more features described on one or more of the following: Section 2 titled “Example Cloud Infrastructure”; Section 5 titled “Example Networks”; and Section 6 titled “Example Network Fabrics.”

In one or more embodiments, the system 500 may include more or fewer components than the components described with reference to FIG. 5. The components described with reference to FIG. 5 may be local to or remote from each other. The components described with reference to FIG. 5 may be implemented in software and/or hardware. The components of system 500 may be distributed over multiple applications and/or machines. Multiple components may be combined into one application and/or machine. Operations described with respect to one component may instead be performed by another component.

In one example, the system 500 may be implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (NAT), a hardware load balancer, a mainframe, a television, a content receiver, a set-top box, a printer, a mobile handset, a smartphone, a personal digital assistant (PDA), a wireless receiver and/or transmitter, a base station, a communication management device, a router, a switch, a controller, an access point, and/or a browser device.

As shown in FIG. 5, the system 500 includes a fabric management engine 502, a data repository 504, a control system 506, and a network devices 508. In one example, the fabric management engine 502 modifies routing configurations of the network devices 508, for example, based on data from the data repository 504 and/or based on data from the control system 506. The fabric management engine 502 may provide instructions to the control system 506 to initiate execution of modifications to the routing configurations of the network devices 508. The control system 506 executes modifications to the routing configurations of the network devices 508, for example, in response to instructions from the fabric management engine 502.

Prior to modifying a routing configuration of the network devices 508, the fabric management engine 502 may determine whether to implement one or more proposed modifications to the routing configuration. The fabric management engine 502 may base the determination on one or more performance metrics corresponding to the one or more proposed modifications. A performance metric may represent an effect that a proposed modification has on the performance of the network devices 508. The performance metric may include a utilization metric, such as a capacity, a utilization, or a headroom. A capacity represents a maximum amount of data that can pass through a network component or set of components in a given time. A utilization represents an amount of data that passes through a network component or set of components in a given time. The term “headroom” represents a difference between the capacity and the utilization (e.g., capacity−utilization=headroom). The term “bandwidth” may also be utilized to refer to headroom. Additionally, or alternatively, the performance metric may include a redundancy metric and/or a resilience parameter. A redundancy metric represents a quantity of alternative links and/or paths. A resilience parameter represents an ability to handle network traffic without performance degradation. A utilization metric may include a link utilization metric, a path utilization metric, or a switch utilization metric. A link utilization metric represents data pertaining one or more particular links between two switches or other devices. A path utilization metric represents data pertaining to one or more pathways across at least a portion of the network devices 508 that include multiple links between particular devices. A switch utilization metric represents data pertaining to a set of ports of one or more particular switches. A utilization metric may pertain to one or more links, paths, or switches of a network devices 508. Additionally, or alternatively, a utilization metric may pertain to one or more portions of a network devices 508.

The fabric management engine 502 may determine performance metrics based on data from the data repository 504 and/or the control system 506. The data may include current or real-time data and/or historical data. Additionally, or alternatively, the data may include forward-looking data, such as schedules, predictions, and/or forecasts. The fabric management engine 502 may compare a performance metric to one or more criteria for determining whether to implement a proposed modification corresponding to the performance metric. In one example, when a performance metric satisfies the one or more criteria, the fabric management engine 502 may implement the proposed modification corresponding to the performance metric. Additionally, or alternatively, when the one or more criteria are unmet by a performance metric satisfies, the fabric management engine 502 may refrain from implementing the proposed modification corresponding to the performance metric.

Additionally, or alternatively, the fabric management engine 502 may steer network traffic across the network devices 508, for example, away from one portion of the network devices 508 and/or towards another portion of the network devices 508. The fabric management engine 502 may steer network traffic based on data from the data repository 504 and/or based on data from the control system 506. The fabric management engine 502 may provide instructions to the control system 506 to steer network traffic towards and/or away from different portions of the network devices 508. The control system 506 steers network traffic towards and/or away from different portions of the network devices 508 in response to instructions from the fabric management engine 502, for example, by executing modifications to the routing configurations of the network devices 508.

The fabric management engine 502 may steer network traffic across the network devices 508 based on one or more performance metrics corresponding to one or more portions of the network devices 508. A performance metric may represent a performance of a particular portion of the network devices 508, such a capacity, a headroom, and/or a utilization of the particular portion of network devices 508. The performance metrics may include current or real-time metrics and/or historical metrics. Additionally, or alternatively, the performance metrics may include forward-looking metrics, such as scheduled metrics, predicted metrics, and/or forecasted metrics. The fabric management engine 502 may determine the performance metrics based on data from the data repository 504 and/or the control system 506. In one example, the fabric management engine 502 steers network traffic towards and/or away from particular portions of the network devices 508 based on one or more criteria. The one or more criteria may include targets, ranges, and/or setpoints for one or more performance metrics. The fabric management engine 502 may steer network traffic towards and/or away from particular portions of the network devices 508 to align one or more performance metrics corresponding to particular portions of the network devices 508 with the one or more criteria.

### A. Example Fabric Management Engine Components

As shown in FIG. 5, a fabric management engine 502 includes one or more of the following modules: a scenario evaluation module 550, a performance metrics module 552, a fabric control module 554, or an update module 556. Additionally, or alternatively, the fabric management engine 502 may include a machine learning system 558.

The scenario evaluation module 550 evaluates candidate scenarios that include proposed modifications to a routing configuration of a network fabric to determine whether to implement the candidate scenarios. The scenario evaluation module 550 may evaluate a particular candidate scenario to determine whether to implement the particular candidate scenario based on one or more criteria corresponding to the particular candidate scenario. Additionally, or alternatively, the scenario evaluation module 550 may compare multiple candidate scenarios to one another to select a candidate scenario to implement from among the multiple candidate scenarios. The scenario evaluation module 550 evaluates candidate scenarios based on performance metrics corresponding to the candidate scenarios.

In one example, the scenario evaluation module 550 compares a performance metric corresponding to a candidate scenario to one or more criteria for proceeding with implementing the candidate scenario. When the scenario evaluation module 550 determines that the performance metric corresponding to the candidate scenario satisfies the one or more criteria, the fabric management engine 502 implements the candidate scenario. The fabric management engine 502 may implement the candidate scenario by directing an instruction to the control system 506 to execute the proposed modification to the routing configuration of the network devices 508. The scenario evaluation module 550 may refrain from implementing a candidate scenario when one or more performance metrics corresponding to the candidate scenario to not meet the one or more criteria for implementing the candidate scenario.

Additionally, or alternatively, the scenario evaluation module 550 may compare multiple candidate scenarios to one another to select a candidate scenario for implementation. In one example, the multiple candidate scenarios include candidate scenarios that satisfy one or more criteria based on one or more performance metrics corresponding to the candidate scenarios, respectively. When the scenario evaluation module 550 determines that the one or more performance metrics corresponding to a candidate scenario satisfy the one or more criteria, the scenario evaluation module 550 may include the candidate scenario in the multiple candidate scenarios. The scenario evaluation module 550 may exclude a candidate scenario that does not satisfy the one or more criteria from the multiple candidate scenarios. After identifying multiple candidate scenarios that satisfy the one or more criteria, the scenario evaluation module 550 may select a candidate scenario from among the multiple candidate scenarios, for example, based on a comparison of the performance metrics corresponding, respectively, to particular candidate scenarios. For example, the scenario evaluation module 550 may select a first candidate scenario over a second candidate scenario based on a comparison of a first performance metric corresponding to the first candidate scenario to a second performance metric corresponding to the second candidate scenario. In one example, the scenario evaluation module 550 selects the first candidate scenario over the second candidate scenario based on the first performance metric being greater than the second performance metric.

The performance metrics module 552 determines performance metrics pertaining to the network devices 508, for example, for use by the scenario evaluation module 550. The performance metrics module 552 may determine performance metrics that correspond to the network devices 508 as a whole and/or to particular portions of the network devices 508. The performance metrics determined by the performance metrics module 552 may include performance metrics current or real-time performance metrics and/or historical performance metrics. Additionally, or alternatively, the performance metrics may include forward-looking performance metrics, such as performance metrics corresponding to schedules, predictions, and/or forecasts. The performance metrics module 552 may determine performance metrics for various routing configurations, including current or real-time routing configurations and/or historical routing configurations. Additionally, or alternatively, the performance metrics module 552 may determine performance metrics for forward-looking routing configurations, such as routing configurations corresponding to schedules, predictions, and/or forecasts.

In one example, the performance metrics module 552 determines performance metrics based on topology data. The topology data represents at least a portion of a topology of the network devices 508. Example topology data is further described below in Subsection B of this Section 3, titled “Example Data Repositories.” Additionally, or alternatively, the performance metrics module 552 may determine performance metrics based on telemetry data. The telemetry data operational data collected from switches and other components of the network devices 508. Example telemetry data is further described below in Subsection C of this Section 3, titled “Example Control System Components and Telemetry Data.”

The fabric control module 554 generates and transmits instructions to the control system 506, for example, to implement modifications to routing configurations of the network devices 508. The instructions generated by the fabric control module 554 may include instructions for implementing candidate scenarios selected by the scenario evaluation module 550. Additionally, or alternatively, the fabric control module 554 may generate instructions based on performance metrics determined by the performance metrics module 552. In one example, the fabric control module 554 generates instructions for steering network traffic across the network fabric based on performance metrics determined by the performance metrics module 552.

The update module 556 generates updates for updating at least a portion of the network devices 508. The updates may include updates to firmware, hardware, and/or software of switches and other components of the network devices 508. The update module 556 may generate candidate scenarios corresponding to updates and direct the candidate scenarios to the scenario evaluation module 550. The scenario evaluation module 550 may accept or reject updates proposed by the update module 556 based on candidate scenarios representing the updates. In one example, when the scenario evaluation module 550 rejects candidate scenario for an update, the update module 556 generates additional candidate scenarios representing alternative updates, for example, until the scenario evaluation module 550 accepts a candidate scenario for implementing the update. In one example, the update module generates update schedules for updating firmware, hardware, and/or software of different portions of the network devices 508. The update schedules may include multiple update phases corresponding to different portion of the network devices 508. Additionally, or alternatively, the update schedule may include a sequence and/or times for implementing an update, for example, according to the multiple update phases corresponding to different portion of the network devices 508.

The machine learning system 558 may include one or more machine learning models that are utilized by the fabric management engine 502 to generate data for use in one or more operations of the system 500. In one example, the scenario evaluation module 550 utilizes the machine learning system 558 to generate and/or evaluate candidate scenarios. Additionally, or alternatively, the performance metrics module may utilize the machine learning system 558 to generate and/or evaluate performance metrics. Additionally, or alternatively, the update module 556 may utilize the machine learning system 558 to generate and/or evaluate updates. In one example, the fabric management engine 502 utilizes the machine learning system 558 to generate forward-looking data, such as schedules, predictions, and/or forecasts associated with one or more operations of the system 500. The forward-looking data generated by the machine learning system 558 may include performance metrics, candidate scenarios, and/or updates. The machine learning system 558 may utilize data from the data repository 504, such as topology data, as inputs to the one or more machine learning models. Additionally, or alternatively, the machine learning system 558 may utilize telemetry data from the control system 506 as inputs to one or more machine learning models. Additionally, or alternatively, the machine learning system 558 may utilize data generated by the fabric management engine 502 as inputs to one or more machine learning models. The machine learning system 558 may include one or more features described below in Section 7, titled “Example Machine Learning System.”

### B. Example Data Repositories

Referring further to FIG. 5, example data repositories 504 are further described. The system 500 may include one or more data repositories 504 that store data associated with one or more components of the system 500. The data stored in a data repository 504 may include data utilized and/or generated by the fabric management engine 502. Additionally, or alternatively, the data stored in a data repository 504 may include data utilized and/or generated by the control system 506. As shown in FIG. 5, the one or more data repositories 504 may include topology data 520, scenario data 522, and/or update data 524.

Topology data 520 includes data that represents at least a portion of a topology of the network devices 508. For example, the topology data may represent a physical and/or logical layout or arrangement of a set of interconnected switches and other components corresponding to at least a portion of the network devices 508. Additionally, or alternatively, the topology data may represent a physical and/or logical arrangement of pathways between switches and other components of at least a portion of the network fabric. Topology data may include data pertaining to fabric architecture, switch positions, link configurations, pathways, and/or logical groupings of the network devices 508. The data pertaining to fabric architecture may represent various architectural aspects of the network devices 508, such as the overall design of the network devices 508 and/or particular topological structures of the network devices 508. Example network fabrics are described below in Section 6 titled “Example Network Fabrics.” The data pertaining to switch positions may include data pertaining to switches and/or placement of switches within the fabric. The data pertaining to link configurations may include data pertaining to connections between switches, such as port mappings and link speeds. The data pertaining to pathways may include data pertaining to available routes for data traversal between switches, such as the number and arrangement of available or redundant pathways. The data pertaining to logical groupings may include data pertaining to logical constructs that overlay the physical topology of the network devices 508. The topology data may include data corresponding to different topologies and/or routing configurations, including a current topology and/or one or more alternative topologies. In one example, the topology data 520 includes data generated from one or more telemetry agents of the control system 506.

Scenario data 522 may include candidate scenarios and/or criteria for comparison against performance metrics for determining whether to implement candidate scenarios. The scenario data may include candidate scenarios and/or criteria to be evaluated by the scenario evaluation module 550. Additionally, or alternatively, the scenario data may include candidate scenarios and/or criteria that were previously evaluated by the scenario evaluation module 550. Additionally, or alternatively, the scenario data 522 may include performance metrics generated and/or utilized by the performance metrics module 552.

Update data 524 may include data for use by the update module 556 to generate updates and/or updates generated by the update module 556. The update data 524 may include data for scheduling updates, such as data pertaining to the type of update, target components for receiving the update, phasing criteria for distributing the update, dependency information, and/or rollback data.

In one or more embodiments, a data repository 504 is any type of storage unit and/or device (e.g., a file system, database, collection of tables, or any other storage mechanism) for storing data. Furthermore, a data repository 504 may include multiple different storage units and/or devices. The multiple different storage units and/or devices may or may not be of the same type or located at the same physical site. Furthermore, a data repository 504 may be implemented or executed on the same computing system as the fabric management engine 502. Additionally, or alternatively, a data repository 504 may be implemented or executed on a computing system separate from the fabric management engine 502. A data repository 504 may be communicatively coupled to the fabric management engine 502 via a direct connection or via a network. Information describing a data repository 504 may be implemented across any of components of the system 500. However, the foregoing information is described with reference to the one or more data repositories 504 for purposes of clarity and explanation.

### C. Example Control System Components and Telemetry Data

Referring further to FIG. 5, example control systems 506 are further described. The system 500 may include one or more control system 506. As shown in FIG. 5, a control system 506 includes a set of telemetry agents 526 and a set of controllers 528 connected to various portions of the network devices 508.

The telemetry agents 526 may include hardware and/or software components that are deployed throughout the network devices 508 to obtain telemetry data. Telemetry agents 526 may be integrated into and/or deployed alongside various switches to collect and export telemetry data. A telemetry agent 526 may interface with a switch via a control plane, a management plane, or directly with an Application-Specific Integrated Circuit (ASIC). A telemetry agent 526 may gather real-time or periodic data. The telemetry agents 526 may transmit telemetry data, for example, to the fabric management engine 502 via one or more network protocols. The telemetry agents 526 may support streaming telemetry and/or push-based delivery that provides real-time data pertaining to the operational state of the network devices 508.

The controllers 528 communicate with switches of the network devices 508 to apply routing configurations to the switches to implement modifications to routing configurations determined by the fabric management engine 502. Additionally, or alternatively, the controllers 528 may compute paths for routing network traffic across the network fabric, enforce routing policies, and/or adapt routing dynamically in response to changes in traffic patterns or device states. The controllers 528 may represent a centralized or distributed system. Additionally, or alternatively, the controllers may apply routing configurations based on telemetry data from the telemetry agents 526.

The telemetry data from the telemetry agents 526 includes real-time or periodic performance and operational metrics collected from switches and other components of the network devices 508, for example, by the telemetry agents 526. The telemetry data may include data pertaining to the status of various switches, such as whether particular switches or groups of switches are operating or out of service. The data pertaining to the status of various switches may include data pertaining to power usage, CPU usage, memory utilization, and/or interface status. Additionally, or alternatively, the telemetry data may include data pertaining to the status of available pathways between switches, such as whether particular pathways are available or unavailable. Additionally, or alternatively, the telemetry data may include data pertaining to the number of available or redundant paths between switches. Additionally, or alternatively, the telemetry data may include data pertaining to network traffic, such as quantitative data pertaining to the volume and/or type of network traffic traversing switches, links, or paths across various portions of the network devices 508. The data pertaining to network traffic may include capacity of switches, utilization of switches, headroom of switches (e.g., capacity−utilization=headroom), packet counts, byte counts, source and destination addresses, protocols, and ports. Additionally, or alternatively, the telemetry data may include data pertaining to error rates, such as quantitative data pertaining to issues affecting data transmission integrity with in the network devices 508. The data pertaining to error rates may include packet drops, cyclic redundancy checks results, data frame conflicts, and/or data retransmissions. Additionally, or alternatively, the telemetry data may include data pertaining to latency, such as quantitative data pertaining to time for transmitting data packets across various portions of the network devices 508. The data pertaining to latency may include one-way latency, round-trip time, congestion, or jitter. Additionally, or alternatively, the telemetry data may include a locking state indicating that a first set of switches located in a first portion of the fabric are prevented from receiving modifications to a first routing configuration of the first set of switches. The locking state may be implemented in connection with an update, for example to the first set of switches. Additionally, or alternatively, the telemetry data may include data pertaining to environmental conditions, such as device temperature, fan speed, or cooling fluid flow rates.

In one example, the telemetry data includes a switch operating metric indicative of an operating state of one or more switch of the network devices 508. The switch operating metric may indicate whether one or more switches are sending and receiving data. In one example, the telemetry agents 526 share telemetry data between switches of the network devices 508. The telemetry data shared by a switch may include routing information, such as data pertaining to available switches that are reachable via one or more pathways from the switch. The telemetry data may include data pertaining to whether or not particular switches are sharing data, such as routing information, with other switches. In one example, a switch that is not sharing data is considered out of service.

Additionally, or alternatively, the telemetry data may include a pathway operating metric indicative of an operating state of one or more pathways for routing data across at least a portion of the network fabric. The pathway operating metric may indicate whether one or more pathways are available for routing network traffic. In one example, a pathway is considered unavailable if a switch corresponding to the pathway is considered out of service.

In one example, the telemetry data includes a physical hardware metric indicative of an operating state of one or more physical hardware devices of the network devices 508. The physical hardware metric may include an L1-type health metric that indicates a status of an L1 layer of various portions of the network devices 508. The L1 layer includes hardware components for transmission of data across the network devices 508, such as switches, cabling, connectors, and transceivers.

In one example, the telemetry data includes one or more management interface metrics indicative of an operating state of one or more infrastructure management services associated with the network devices 508. A management interface metric may indicate a health of one or more cloud services. Additionally, or alternatively, a management interface metric may indicate a health of health of one or more infrastructure management modules, such as management consoles for managing cloud infrastructure, application programming interfaces (APIs) for provisioning and managing resources, and/or services for instantiating and managing compute instances, storage, or other cloud resources.

### D. Example Network Traffic Pathways Across a Network Fabric

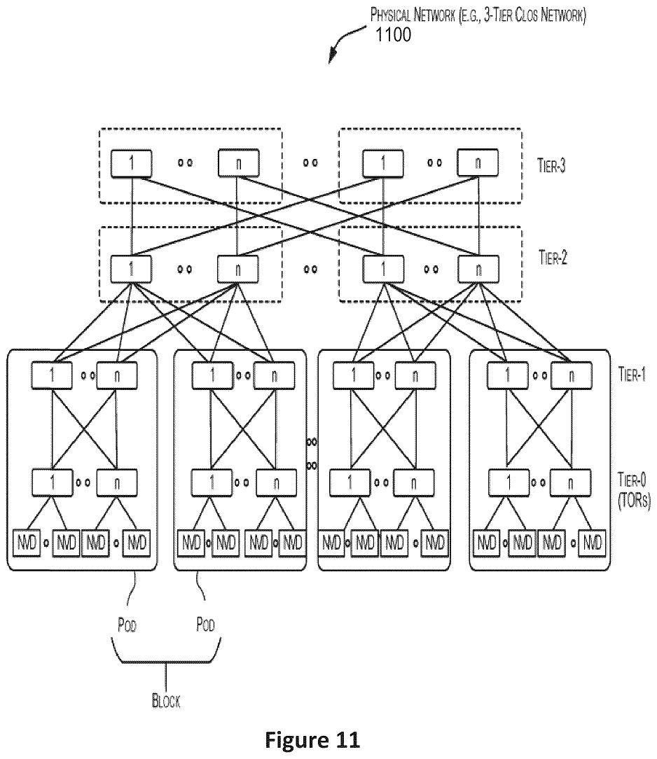

Example network fabrics are described below in Section 6 titled “Example Network Fabrics.” Section 6 describes FIG. 11, which depicts a simplified block diagram of a physical network provided by a CI according to certain embodiments. As further described in Section 6, the embodiment depicted in FIG. 11 is a 3-tiered network comprising tiers 1, 2, and 3. TOR switches (which are coupled to network virtualization devices (NVDs), and in turn coupled to host machines or computing devices) represent Tier-0 switches in a Clos network. The Tier-0 switches are connected to Tier-1 switches (also referred to as leaf switches). In the embodiment depicted in FIG. 11, a set of “n” Tier-0 TOR switches are connected to a set of “n” Tier-1 switches and together form a pod. Each Tier-0 switch in a pod is interconnected to all the Tier-1 switches in the pod, but there is no connectivity of switches between pods. In certain implementations, two pods are referred to as a block. Each block is served by or connected to a set of “n” Tier-2 switches (sometimes referred to as spine switches). There can be several blocks in the physical network topology. The Tier-2 switches are in turn connected to “n” Tier-3 switches (sometimes referred to as super-spine switches). Communication of packets over physical network 1100 is typically performed using one or more Layer-3 communication protocols. Typically, all the layers of the physical network, except for the TORs layer are n-ways redundant thus allowing for high availability. Policies may be specified for pods and blocks to control the visibility of switches to each other in the physical network so as to enable scaling of the physical network.

The connections between the switches and the computing devices define multiple pathways between particular sets of computing devices. These pathways represent alternative or redundant pathways for routing network traffic to a computing device and/or between sets of computing devices.

The quantity of available pathways to or from a computing device depends at least in part on the quantity of connections between switches that have an active operating state. The quantity of available pathways to or from a computing device is decreased based at least in part on the quantity of switches that have an inactive operating state and that are located along a potential pathway to or from the computing device. A switch that has an inactive operating state decreases the quantity of available pathways to or from a computing device at least by the quantity of potential pathways that pass through that switch. Additionally, or alternatively, a switch that has an inactive operating state may decrease a capacity and/or headroom of other switches that are connected to the inactive switch based at least on the decrease in available pathways corresponding to the inactive switch. Additionally, or alternatively, a switch that has an inactive operating state may decrease a capacity and/or headroom of a block that includes the inactive switch based at least on the decrease in available pathways corresponding to the inactive switch.

When on one or more switches have an inactive operating state that renders unavailable one or more pathways to or from a computing device, data can be routed through one or more other pathways to or from the computing device. The particular pathways that are utilized to route data may depend at least in part on a routing configuration corresponding to one or more portions of the fabric. The routing configuration corresponding to one or more portions of the fabric can be modified to accommodate candidate scenarios that include different sets of switches that have an active or inactive operating state. The modification to the routing configuration can be based on telemetry data and/or topology data associated with at least a portion of the fabric. Additionally, or alternatively, the routing configuration of one or more portions of the fabric can be modified to steer network traffic towards or away from different portions of the fabric based on different set of switches that have an active or inactive operating state. The routing configuration can be modified based on telemetry data and/or topology data associated with at least a portion of the fabric.

### E. Example Control System for a Network Fabric

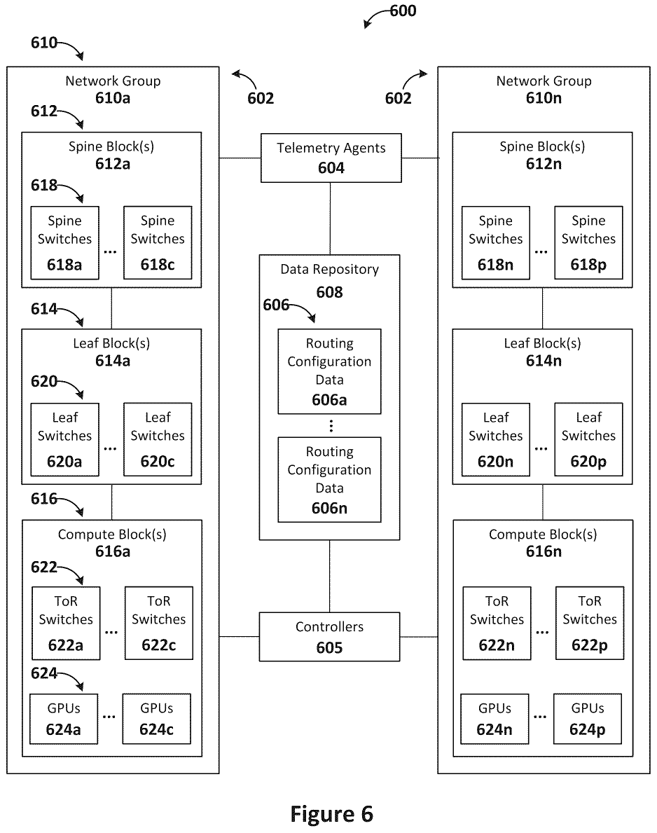

Referring to FIG. 6, an example control system 600 associated with a network fabric is further described. In one example, the system 500 described with reference to FIG. 5 may include one or more features of the example control system 600 described with reference to FIG. 6. The control system 600 may execute operations pertaining to modifying routing configurations of a network fabric 602 and/or steering network traffic across the network fabric 602. As shown in FIG. 6, the control system 600 includes a set of telemetry agents 604 and a set of controllers 605 respectively connected to various portions of the fabric 602. As further shown, the control system 600 includes one or more sets of routing configuration data 606, such as routing configuration data 606a and routing configuration data 606n. The routing configuration data 606 may be stored in one or more data repositories 608. The one or more data repositories 608 may represent a portion of the control system 600 and/or a portion of the system 500 described with reference to FIG. 5. The one or more data repositories 608 may be located locally or remotely relative to the various switches and/or computing devices of the fabric 602. The various switches of the fabric 602 utilize the routing configuration data 606 to route network traffic across the fabric 602. Different portions of the fabric 602 may utilize different sets of routing configuration data 606. For example, a first portion of the fabric 602 may utilize routing configuration data 606a and a second portion of the fabric 602 may utilize routing configuration data 606n.

As shown in FIG. 6, the fabric 602 includes multiple network groups 610, such as network group 610a and network group 610n. A network group 610 includes a physical and/or logical grouping of switches corresponding to a portion of the fabric 602. Switches associated with different network groups 610 may utilize different routing configuration data 606 for routing network traffic. In one example, switches associated with network group 610a utilize routing configuration data 606a and switches associated with network group 610n utilize routing configuration data 606n. The network groups 610 include, respectively, one or more spine blocks 612, one or more leaf blocks 614, and one or more compute blocks 616. In one example, network group 610a includes spine block(s) 612a, leaf blocks 614a, and compute blocks 616a. Additionally, or alternatively, network group 610n may include spine block(s) 612n, leaf blocks 614n, and compute blocks 616n.

A spine block 612 includes a set of spine switches 618. In one example, spine block 612a includes a first set of spine switches 618, such as spine switch 618a and spine switch 618c. Additionally, or alternatively, spine block 612n includes a second set of spine switches 618, such as spine switch 618n and spine switch 618p. The spine switches 618 associated with different spine blocks 612 may utilize different routing configuration data 606 for routing network traffic. In one example, spine switches 618 associated with spine block 612a utilize routing configuration data 606a and spine switches 618 associated with spine block 612n utilize routing configuration data 606n. Additionally, or alternatively, different spine switches 618 within a spine block 612 may utilize different routing configuration data 606. In one example, spine switch 618a utilizes routing configuration data 606a and spine switch 618c utilizes routing configuration data 606n.

A leaf block 614 includes a set of leaf switches 620. In one example, leaf block 614a includes a first set of leaf switches 620, such as leaf switch 620a and leaf switch 620c. Additionally, or alternatively, leaf block 614n includes a second set of leaf switches 620, such as leaf switch 620n and leaf switch 620p. The leaf switches 620 associated with different leaf blocks 614 may utilize different routing configuration data 606 for routing network traffic. In one example, leaf switches 620 associated with leaf block 614a utilize routing configuration data 606a and leaf switches 620 associated with leaf block 614n utilize routing configuration data 606n. Additionally, or alternatively, different leaf switches 620 within a leaf block 614 may utilize different routing configuration data 606. In one example, leaf switch 620a utilizes routing configuration data 606a and leaf switch 620c utilizes routing configuration data 606n.

A compute block 616 includes a set of ToR switches 622 and a set of computing devise 624, such as GPUs or TPUs. Different ToR switches 622 are connected to different computing devices 624. In one example, compute block 616a includes a first set of ToR switches 622, such as ToR switch 622a and ToR switch 622c. Additionally, or alternatively, compute block 616n includes a second set of ToR switches 622, such as ToR switch 622n and ToR switch 622p. The ToR switches 622 associated with different compute blocks 616 may utilize different routing configuration data 606 for routing network traffic. In one example, ToR switches 622 associated with compute block 616a utilize routing configuration data 606a and ToR switches 622 associated with compute block 616n utilize routing configuration data 606n. Additionally, or alternatively, different ToR switches 622 within a compute block 616 may utilize different routing configuration data 606. In one example, ToR switch 622a utilizes routing configuration data 606a and ToR switch 622c utilizes routing configuration data 606n.

The routing configuration data 606 includes data pertaining to available pathways between particular switches and/or computing devices corresponding to the fabric 602. The routing configuration data 606 includes data pertaining to routing protocols for routing network traffic between particular switches and/or computing devices corresponding the fabric 602. In one example, a routing protocol includes path selection algorithm. The system may execute a path selection algorithm to select a particular switch and/or path for routing network traffic. The path selection algorithm may include one or more routing parameters. The system may modify the routing configuration at least by modifying a routing parameter utilized by a path selection algorithm. A switch and/or path may be predefined for selection by the path selection algorithm. Additionally, or alternatively, the path selection algorithm may select a switch and/or path based on one or more parameters associated with the fabric 602. Additionally, or alternatively, the path selection algorithm selects a switch and/or path based on one or more performance metrics. In one example, a routing protocol includes an equal-cost mutli-path (ECMP) protocol. An ECMP protocol enables load balancing by distributing network traffic across multiple paths of equal cost between a source and a destination. The cost may be based on one or more performance metrics, such as hop count, capacity, headroom, and/or latency. Switches may utilize a hashing algorithm to select a path via an ECMP protocol.

In one example, the control system 600 modifies the routing configuration data 606 corresponding to one or more portions of the fabric 602 to change the available pathways that can be selected by a switch when routing network traffic. Additionally, or alternatively, the control system 600 may modify the routing configuration data 606 to change the pathways that the switch will select when routing network traffic. The control system 600 may modify the routing configuration data 606 based on instructions from the fabric management engine 502 (FIG. 5). In one example, the modification to the routing configuration represents a change to a set of switches corresponding to a portion of the fabric 602 that are available or unavailable for routing traffic, for example, based on an update deployment process that impacts the availability of the set of switches. Additionally, or alternatively the modification to the routing configuration may include a routing parameter that preferentially steers network traffic away from one portion of the fabric 602 and/or towards another portion of the fabric 602.

### F. Example Interfaces

Referring again to FIG. 5, the system 500 may include a user device interface 530 communicatively coupled or couplable with one or more other components of the system 500. A user device interface 530 may include hardware and/or software configured to facilitate interactions between a user and various aspects of the system 500. The user device interface 530 may render user interface elements and receive input via user interface elements. For example, the user device interface 530 may display outputs generated by the system 500. Additionally, or alternatively, the user device interface 530 may be configured to provide inputs to the system 500. Examples of interfaces include a graphical user interface (GUI), a command line interface (CLI), a haptic interface, or a voice command interface. Examples of user interface elements include checkboxes, radio buttons, dropdown lists, list boxes, buttons, toggles, text fields, date and time selectors, command lines, sliders, pages, or forms. Any one or more of these interfaces or interface elements may be utilized by a user device interface 530.

In an embodiment, different components of a user device interface 530 are specified in different languages. The behavior of user interface elements is specified in a dynamic programming language such as JavaScript. The content of user interface elements is specified in a markup language, such as hypertext markup language (HTML) or XML User Interface Language (XUL). The layout of user interface elements is specified in a style sheet language such as Cascading Style Sheets (CSS). Alternatively, a user device interface 530 may be specified in one or more other languages, such as Java, C, or C++.

Additionally, or alternatively, the system 500 may include one or more communications interfaces 532 communicatively coupled or couplable with one or more components of the system 500. The one or more communications interfaces 532 may include hardware and/or software configured to transmit data between respective components of the system 500 and/or to transmit data to and/or from the system 500. For example, a communications interface 532 may transmit and/or receive data between and/or among one or more components of the system 500.

### 4. Example Operations Pertaining to Fabric Management

Referring to FIGS. 7 and 8, operations pertaining to modifying routing configurations of a network fabric and/or steering network traffic across the network fabric are further described. One or more operations described with reference to FIGS. 7 and 8 may be modified, rearranged, or omitted. Accordingly, the particular sequence of operations described with reference to FIGS. 7 and 8 should not be construed as limiting the scope of one or more embodiments. In one example, the operations described with reference to FIGS. 7 and 8 may be performed by one or more features of the system described with reference to FIG. 5.

### A. Operations Pertaining to Modifying Routing Configurations of a Network Fabric

Referring to FIG. 7, operations 700 pertaining to modifying routing configurations of a network fabric are further described. As described with reference to FIG. 7, a system modifies routing configurations of a network fabric to implement candidate scenarios when performance metrics corresponding to the candidate scenarios satisfy criteria for proceeding with the candidate scenarios.

As shown in FIG. 7, a system receives a candidate scenario that includes a proposed modification to a routing configuration of a fabric organized according to a fabric topology (Operation 702). In one example, the system receives a candidate scenario as an input from a user interface. Additionally, or alternatively, the system may receive the candidate scenario from an update module in association with a proposed update to the fabric. Additionally, or alternatively, the system may retrieve candidate scenarios from a data repository.

In one example, the proposed modification includes modifying a routing configuration corresponding to a first portion of the fabric such that a first set of switches are unavailable. Additionally, or alternatively, the proposed modification may include modifying a routing configuration corresponding to a second portion of the fabric such that a second set of switches are available. In one example, the modification to the routing configuration includes a modification to a quantity of available pathways between a first computing device and a second computing device, for example, via at least a portion of a Remote Direct Memory Access (RDMA) fabric. In one example, the proposed modification includes modifying the routing configuration of at least a portion of the fabric in accordance with a sequence for executing an update.

The proposed modification may include modifying a routing configuration to increase or decrease one or more utilization metrics corresponding to one or more portions of the fabric. The one or more utilization metrics may include a link utilization metric, a path utilization metric, or switch utilization metric. In one example, the proposed modification may include modifying a routing configuration corresponding to a first portion of the fabric such that a first utilization metric associated with the first portion of the fabric is decreased. The modification to the routing configuration corresponding to the first portion of the fabric may include decreasing a capacity of the first portion of the fabric. Additionally, or alternatively, the proposed modification may include modifying a routing configuration corresponding to a second portion of the fabric such that a second utilization metric associated with the second portion of the fabric is increased. The modification to the routing configuration corresponding to the second portion of the fabric may include increasing a capacity of the second portion of the fabric.

After receiving a candidate scenario, the system determines a performance metric corresponding to the candidate scenario (Operation 704). The system may determine the performance metric by invoking one or more performance metric APIs that generate performance metrics based on telemetry data and/or fabric topology data. The performance metric may correspond to the proposed modification to the routing configuration based on the candidate scenario. For example, the performance metric may represent an effect of implementing the candidate scenario by modifying the routing configuration. The system may determine the performance metric based at least on the fabric topology of the fabric and telemetry data associated with the fabric. The telemetry data may be determined or detected in real time. In one example, the system determines the telemetry data contemporaneously with the determination of the performance metric corresponding to the candidate scenario. The system may access the fabric topology from a data repository. The fabric topology may be determined before the fabric is implemented. The system may determine the telemetry data after the fabric is implemented.

In one example, the performance metric includes a capacity metric corresponding to the candidate scenario. The capacity metric may be associated with at least a portion of the fabric. Additionally, or alternatively, the performance metric may include a redundancy metric indicative of a level of redundancy of at least a portion of the fabric. In one example, the system determines the performance metric based on a capacity of a set of active pathways corresponding to a portion of the fabric. The system may determine a quantity of a set of active pathways, for example, between a first switch and a second switch. Upon determining the quantity of a set of active pathways, the system may determine a capacity of the set of active pathways. Based on the capacity of the set of active pathways, the system may determine the performance metric. To determine the quantity of the set of active pathways, the system may identify a set of pathways, for example, between the first switch and the second switch, based on the fabric topology. Upon identifying the set of pathways, the system may determine an operating state for particular pathways of the set of pathways based on the telemetry data. The operation state may indicate whether particular pathways are active or inactive. The system may determine a quantity of the particular pathways that have an active operating state. Upon determining the quantity of pathways that have an active operating state, the system may designate the quantity of pathways that have an active operating state as the quantity of the set of active pathways. In one example, the system may determine that one or more particular pathways have an operating state of inactive. When determining the quantity of the set of active pathways, the system may exclude, from the quantity of the set of active pathways, the one or more particular pathways that have the operating state of inactive.

Compare the performance metric to a criterion for proceeding with implementing the candidate scenario (Operation 706). In one example, the criterion for proceeding with implementing the candidate scenario includes a threshold. In one example, the performance metric satisfies the criterion when the performance metric meets the threshold. In one example, the system utilizes different thresholds as the criterion for proceeding with implementing the candidate scenario for different circumstances. The difference thresholds may correspond to different priority levels for implementing a scenario. The different priority levels may be associated with different types of data, different services, different resources, and/or different customers. Additionally, or alternatively, the different priority levels may be associated with different reasons for modifying the routing configuration. For example, different types of updates may have different priority levels. The system may determine a priority level for data routing between the set of computing devices linked to the fabric. Based on the priority level, the system may determine the criterion for proceeding with implementing the candidate scenario.

In one example, the criterion for proceeding with implementing the candidate scenario is based on an effect of implementing the candidate scenario. For example, the criterion may be based on an effect on one or more performance metrics, such as a capacity metric, corresponding to a current routing configuration of the fabric. The system may determine the performance metric corresponding to the current routing configuration of the fabric based on the fabric topology and the telemetry data. The performance metric capacity metric may be associated with at least a portion of the fabric. The system may determine whether the criterion for proceeding with implementing the candidate scenario is satisfied based on the performance metric corresponding to the current routing configuration. In one example, the criterion for proceeding with implementing the candidate scenario includes the performance metric corresponding to the candidate scenario being within a specified range of the performance metric corresponding to the current routing configuration. For example, the criterion may be satisfied by a performance metric corresponding to the candidate scenario being greater than the performance metric corresponding to the current routing configuration.

Based on the comparison of the performance metric to the criterion for proceeding with implementing the candidate scenario, the system determines whether the performance metric satisfies the criterion (Operation 708). When the system determines that the performance metric satisfies the criterion, the system generates an instruction for implementing the candidate scenario (Operation 710). The system may utilize an API to generate the instruction. The API may provide an interface that translates the instruction into a format or protocol that is supported by a recipient of the instruction. Additionally, or alternatively, the system may utilize the API to encode the instruction in a machine-readable format. The instruction may include a modification to the routing configuration of the fabric corresponding to the candidate scenario. After generating the instruction, the system initiates execution of the instruction for implementing the candidate scenario (Operation 712). The system may initiate execution of the instruction by applying the modification to the routing configuration. When the system determines that the criterion is not satisfied by the performance metric, the system refrains from implementing the candidate scenario (Operation 714). In one example, refraining from implementing the candidate scenario may include generating a response that indicates, for example, that the candidate scenario is not being implemented and/or that the performance metric does not satisfy the criterion for implementing the candidate scenario. The system may transmit the response to a source of the candidate scenario, such as a user interface and/or an update module. Additionally, or alternatively, the response may include a log entry. The system may record the log entry in a log file located in a data repository.

In one example, the system compares multiple candidate scenarios to one another. The system may determine that a criterion for proceeding with a candidate scenario is satisfied when a performance metric corresponding to the candidate scenario exceeds another performance metric corresponding to another candidate scenario. The system may select a particular candidate scenario over another candidate scenario in response to determining that the performance metric of the particular candidate scenario exceeds the performance metric of the other candidate scenario.

In one example, a candidate scenario includes a time for modifying the routing configuration of the fabric. The system may determine the performance metric based on a calendar event coinciding with the time for modifying the routing configuration of the fabric. In one example, the system may evaluate multiple candidate scenarios corresponding to different times for modifying the routing configuration of the fabric. Additionally, or alternatively, the system may evaluate performance metrics for different calendar events. The calendar events may include operational activities, maintenance events, and/or data utilization periods. The calendar events may include scheduled, forecasted, and/or predicted events.

In one example, a candidate scenario may correspond to an update to firmware, hardware, and/or software. The update may correspond to a set of switches located in one or more portions of the fabric. The set of switches and/or the one or more portions of the fabric may be unavailable when executing the update. The proposed modification may include modifying the routing configuration of the fabric such that the set of switches are unavailable. Additionally, or alternatively, the proposed modification may include modifying the routing configuration of the fabric in response to the set of switches being unavailable. In one example, the candidate scenario may include increasing a utilization metric associated with a portion of the fabric based on the set of switches being unavailable, for example, when executing the update. The proposed modification may include modifying the routing configuration of the fabric such that the utilization metric is increased.

In one example, a candidate scenario includes a sequence for executing the update for a series of sets of switches of the fabric. A first phase of the sequence may include executing the update for a first set of switches located in a first portion of the fabric. A second phase of the sequence may include, subsequent to executing the update for the first set of switches, executing the update for a second set of switches located in a second portion of the fabric. The proposed modification may include modifying the routing configuration of the fabric in accordance with the sequence for executing the update. In one example, the proposed modification may include a first modification to the routing configuration of the fabric corresponding to the first phase of the sequence and a second modification to the routing configuration of the fabric corresponding to the second phase of the sequence.

In one example, a candidate scenario may include decreasing a capacity of a first portion of the fabric and increasing a utilization of a second portion of the fabric. The proposed modification may include modifying the routing configuration of the fabric to decrease the capacity of the first portion of the fabric and increase the utilization of the second portion of the fabric. The decrease in capacity of the first portion of the fabric may correspond to a set of switches corresponding to the first portion of the fabric having an unavailable operating state, for example, in connection with an update to the set of switches. The increase in utilization of the second portion of the fabric may absorb at least a portion of network traffic from the first portion of the fabric. The increase in utilization of the second portion of the fabric at meat partially avoids a performance degradation of at least a portion of the fabric. In one example, the candidate scenario may include the first portion of the fabric continuing to handle network traffic, for example, while at least partially avoiding performance degradation, during the time when the set of switches corresponding to the first portion of the fabric have an unavailable operating state. Additionally, or alternatively, the candidate scenario may include the second portion of the fabric handling network traffic in lieu of the first portion of the fabric, for example, to at least partially avoid performance degradation, during the time when the set of switches corresponding to the first portion of the fabric have an unavailable operating state.

### B. Operations Pertaining to Steering Network Traffic Across a Network Fabric

Referring to FIG. 8, operations 800 pertaining to steering network traffic across the network fabric are further described. As described with reference to FIG. 8, a system steers network traffic from a first subsection of the fabric to a second subsection of the fabric based on performance metrics determined from fabric topology and the telemetry data. As shown in FIG. 8, a system obtains telemetry data associated with a fabric organized according to a fabric topology (Operation 802). The system may obtain the telemetry data from a set of telemetry agents. The telemetry data may be determined or detected in real time. The telemetry data may represent real-time network traffic routed across the fabric.

The system accesses a fabric topology, and based on the fabric topology, the system determines a portion of the telemetry data corresponding to a subsection of the fabric (Operation 804). In one example, the subsection of the fabric includes a set of leaf switches. Additionally, or alternatively, the section of the fabric may include a set of spine switches. The subsection of the fabric may include one or more blocks, such as one or more spine blocks, one or more leaf blocks, and/or one or more compute blocks. Additionally, or alternatively, the subsection of the fabric may include one or more network groups.

Based on the fabric topology and the portion of the telemetry data corresponding to the subsection of the fabric, the system determines a performance metric corresponding to the subsection of the fabric (Operation 806). The system may determine the performance metric by invoking one or more performance metric APIs that generate performance metrics based on telemetry data and/or fabric topology data. The performance metric one or more of the following: a physical hardware metric, a management interface metric, or a switch operating metric, a redundancy metric. In one example, the system determines the performance metric based on a quantity of active pathways corresponding to the subsection of the fabric. The system may determine a quantity of a set of active pathways, for example, between a first switch and a second switch. Upon determining the quantity of a set of active pathways, the system may determine a capacity of the set of active pathways. Based on the capacity of the set of active pathways, the system may determine the performance metric. To determine the quantity of the set of active pathways, the system may identify a set of pathways, for example, between the first switch and the second switch, based on the fabric topology. Upon identifying the set of pathways, the system may determine an operating state for particular pathways of the set of pathways based on the telemetry data. The operation state may indicate whether particular pathways are active or inactive. The system may determine a quantity of the particular pathways that have an active operating state. Upon determining the quantity of pathways that have an active operating state, the system may designate the quantity of pathways that have an active operating state as the quantity of the set of active pathways. In one example, the system may determine that one or more particular pathways have an operating state of inactive. When determining the quantity of the set of active pathways, the system may exclude, from the quantity of the set of active pathways, the one or more particular pathways that have the operating state of inactive. In one example, the subsection of the fabric includes a set of switches and a portion of the telemetry data is indicative of the set of switches being out of service. The performance metric may be attributable at least in part to the set of switches being out of service. The set of switches may be out of service based on one or more of the following: receiving an update, being offline, an outage, or scheduled downtime.

After determining the performance metric, the system compares the performance metric to a performance criterion (Operation 808). In one example, the performance criterion includes a threshold or a range. Additionally, or alternatively, the performance criterion may include an upper threshold and/or a lower threshold. In one example, the performance metric satisfies the performance criterion when the performance metric meets the threshold or the range. In one example, the system utilizes different thresholds or ranges as the performance criterion for different circumstances. The difference thresholds or ranges may correspond to different priority levels. The different priority levels may be associated with different types of data, different services, different resources, and/or different customers that are utilizing the subsection of the fabric. The system may determine a priority level for data routing between the set of computing devices linked to the subsection of the fabric. Based on the priority level, the system may determine the performance criterion.

Based on the comparison of the performance metric to the performance criterion, the system determines whether the performance metric satisfies the performance criterion (Operation 810). When the system determines that the performance metric satisfies the performance criterion, the system may maintain a status quo of a current operating state and/or the system may steer traffic towards or away from the subsection of the fabric (Operation 812). Additionally, or alternatively, when the system determines that the performance metric does not satisfy the performance criterion, the system may steer traffic away from the subsection of the fabric (Operation 814). The system may utilize different performance criterion for determining whether to maintain the status quo, to steer traffic towards the subsection of the fabric, or to steer traffic away from the subsection of the fabric. In one example, the system steers network traffic towards subsections of the fabric that have relatively more available headroom and/or away from subsections of the fabric that have relatively less available headroom. Additionally, or alternatively, the system may maintain a status quo of a current operating state of subsections of the fabric that have an available headroom within a specified range.

In one example, based on the telemetry data, the system determines a utilization metric associated with the subsection of the fabric. Additionally, or alternatively, the system may determine a headroom of the subsection of the fabric, for example, based on the utilization metric. In one example, the system determines a capacity metric associated with the subsection of the fabric. The system may determine the headroom based on a difference between the capacity metric and the utilization metric. The system may determine whether the performance metric satisfies the threshold at least by determining whether the headroom satisfies the threshold.

In one example, the system steers network traffic by modifying a routing configuration for at least a portion of the fabric. Steering network traffic includes modifying the volume of network traffic being routed across a subsection of the fabric. Modifying the volume of network traffic includes at least one of: steering network traffic towards a subsection of the fabric, or steering network traffic away from a subsection of the fabric. In one example, based on modifying the routing configuration, a portion of the network traffic is routed across the subsection of the fabric that would not be routed across the subsection of the fabric without modifying the routing configuration. Additionally, or alternatively, a modification to the routing configuration may cause a portion of the network traffic to be not routed across a subsection of the fabric that would have been routed across the subsection of the fabric without the modification to the routing configuration.

In one example, the system modifies a routing protocol executable by one or more to route network traffic across at least a portion of the fabric. Based on modifying the routing protocol, execution of the routing protocol produces at least one of: a decrease in network traffic across the first subsection of the fabric, or an increase in network traffic across the second subsection of the fabric. The system may steer network traffic away from a first subsection of the fabric and towards a second subsection of the fabric by modifying a routing protocol executable by one or more switches. The one or more switches may correspond to the first subsection of the fabric and/or the second subsection of the fabric. In one example, the first subsection of the fabric includes a first set of switches and the second subsection of the fabric includes a second set of switches. Based on modifying the routing protocol, the one or more switches preferentially route network traffic across the second subsection of the fabric by directing at least some of the network traffic to the second set of switches in lieu of the first set of switches. In one example, the system steers network traffic towards a subsection of the fabric that meets a lower capacity threshold. Additionally, or alternatively, the system may steer network traffic away from a subsection of the fabric that meets an upper capacity threshold.

In one example, the system modifies a routing parameter utilized in a path selection protocol that is executable by one or more switches to select target destinations for routing network traffic along a set of available paths. The subsection of the fabric includes a first target destination on a first path from a switch to a computing device and second target destination on a second path from the switch to the computing device. Based on modifying the routing parameter, the path selection protocol, when executed by the switch, preferentially returns the first target destination for selection by the switch over the second target destination.

In one example, the system steers network traffic away from a first set of leaf switches and/or towards a second set of leaf switches. The first set of leaf switches and the second set of leaf may be connected to a particular set of computing devices, for example, via ToR switches. The first set of leaf switches may correspond to a first leaf block and the second set of leaf switches may correspond to a second leaf block. The system may preferentially route network traffic to the set of computing devices via the second set of leaf switches relative to the first set of leaf switches. Additionally, or alternatively, the system may steer network traffic away from a first set of spine switches and/or towards a second set of spine switches. The first set of spine switches and the second set of spine may be connected to a particular set of leaf switches. The first set of spine switches may correspond to a first spine block and the second set of spine switches may correspond to a second spine block. The system may preferentially route network traffic to the set of leaf switches via the second set of spine switches relative to the first set of spine switches.

In one example, the system steers network traffic away from a first set of computing devices and/or towards a second set of computing devices. A first subsection of the fabric may include a first set of switches connected to the first set of computing devices and a second subsection of the fabric may include a second set of switches connected to the second set of computing devices. The system may preferentially route network traffic to the second set of computing devices via the second set of switches relative to routing network traffic to the first set of computing devices via the first set of switches. Additionally, or alternatively, the system may

Additionally, or alternatively, the system may steer network traffic away from a network group and/or towards a second network group. The first network group may include a first set of spine switches and/or a first set of leaf switches. The second network group may include a second set of spine switches and/or a second set of leaf switches. The first network group may be connected to a first set of computing devices and the second network group may be connected to a second set of computing devises. The system may preferentially route network traffic to the second set of computing devices via the second network group relative to network traffic routed to the first set of computing devices via the first network group.

In one example, the fabric includes an RDMA fabric. In one example, by steering network traffic away from a first subsection of the fabric and/or towards a second subsection of the fabric, the system increases network traffic between a first set of computing devices linked to the RDMA fabric. Additionally, or alternatively, by steering network traffic away from a first subsection of the fabric and/or towards a second subsection of the fabric, the system may decrease network traffic between a second set of computing device linked to the RDMA fabric.

### 5. Example Cloud Networks

As noted above, infrastructure as a service (IaaS) is one particular type of cloud computing service. In an IaaS model, customers can build their own customizable virtual or overlay networks and deploy customer resources over on-demand, scalable computing resources of CI.

The CI may comprise interconnected high-performance compute resources including various host machines, memory resources, and network resources that form a physical network, which is also referred to as a substrate network or an underlay network. The resources in CI may be spread across one or more data centers that may be geographically spread across one or more geographical regions. Virtualization software may be executed by these physical resources to provide a virtualized distributed environment. The virtualization creates an overlay network (also known as a software-based network, a software-defined network, or a virtual network) over the physical network. The CI physical network provides the underlying basis for creating one or more overlay or virtual networks on top of the physical network. The physical network (or substrate network or underlay network) comprises physical network devices such as physical switches, routers, computers and host machines, and the like. An overlay network is a logical (or virtual) network that runs on top of a physical substrate network. A given physical network can support one or multiple overlay networks. Overlay networks typically use encapsulation techniques to differentiate between traffic belonging to different overlay networks. A virtual or overlay network is also referred to as a virtual cloud network (VCN). The virtual networks are implemented using software virtualization technologies (e.g., hypervisors, virtualization functions implemented by network virtualization devices (NVDs) (e.g., smartNICs), top-of-rack (TOR) switches, smart TORs that implement one or more functions performed by an NVD, and other mechanisms) to create layers of network abstraction that can be run on top of the physical network. Virtual networks can take on many forms, including peer-to-peer networks, IP networks, and others. Virtual networks are typically either Layer-3 IP networks or Layer-2 VLANs. This method of virtual or overlay networking is often referred to as virtual or overlay Layer-3 networking. Examples of protocols developed for virtual networks include IP-in-IP (or Generic Routing Encapsulation (GRE)) Virtual Extensible LAN (VXLAN—IETF RFC 7348), Virtual Private Networks (VPNs) (e.g., MPLS Layer-3 Virtual Private Networks (RFC 4364)), VMware's NSX, GENEVE (Generic Network Virtualization Encapsulation), and others.

In a physical network, a network endpoint (“endpoint”) refers to a computing device or system that is connected to a physical network and communicates back and forth with the network to which it is connected. A network endpoint in the physical network may be connected to a Local Area Network (LAN), a Wide Area Network (WAN), or other type of physical network. Examples of traditional endpoints in a physical network include modems, hubs, bridges, switches, routers, and other networking devices, physical computers (or host machines), and the like. Each physical device in the physical network has a fixed network address that can be used to communicate with the device. This fixed network address can be a Layer-2 address (e.g., a MAC address), a fixed Layer-3 address (e.g., an IP address), and the like. In a virtualized environment or in a virtual network, the endpoints can include various virtual endpoints such as virtual machines that are hosted by components of the physical network (e.g., hosted by physical host machines). These endpoints in the virtual network are addressed by overlay addresses such as overlay Layer-2 addresses (e.g., overlay MAC addresses) and overlay Layer-3 addresses (e.g., overlay IP addresses). Network overlays enable flexibility by allowing network managers to move around the overlay addresses associated with network endpoints using software management (e.g., via software implementing a control plane for the virtual network). Accordingly, unlike in a physical network, in a virtual network, an overlay address (e.g., an overlay IP address) can be moved from one endpoint to another using network management software. Since the virtual network is built on top of a physical network, communications between components in the virtual network involves both the virtual network and the underlying physical network. In order to facilitate such communications, the components of CI are configured to learn and store mappings that map overlay addresses in the virtual network to actual physical addresses in the substrate network, and vice versa. These mappings are then used to facilitate the communications. Customer traffic is encapsulated to facilitate routing in the virtual network.

Accordingly, physical addresses (e.g., physical IP addresses) are associated with components in physical networks and overlay addresses (e.g., overlay IP addresses) are associated with entities in virtual or overlay networks. A physical IP address is an IP address associated with a physical device (e.g., a network device) in the substrate or physical network. For example, each NVD has an associated physical IP address. An overlay IP address is an overlay address associated with an entity in an overlay network, such as with a compute instance in a customer's virtual cloud network (VCN). Two different customers or tenants, each with their own private VCNs can potentially use the same overlay IP address in their VCNs without any knowledge of each other. Both the physical IP addresses and overlay IP addresses are types of real IP addresses. These are separate from virtual IP addresses. A virtual IP address is typically a single IP address that represents or maps to multiple real IP addresses. A virtual IP address provides a 1-to-many mapping between the virtual IP address and multiple real IP addresses. For example, a load balancer may use a VIP to map to or represent multiple servers, each server having its own real IP address.

The cloud infrastructure or CI is physically hosted in one or more data centers in one or more regions around the world. The CI may include components in the physical or substrate network and virtualized components (e.g., virtual networks, compute instances, virtual machines, etc.) that are in a virtual network built on top of the physical network components. In certain embodiments, the CI is organized and hosted in realms, regions, and availability domains.

When a customer subscribes to an IaaS service, resources from CI are provisioned for the customer and associated with the customer's tenancy. The customer can use these provisioned resources to build private networks and deploy resources on these networks. The customer networks that are hosted in the cloud by the CI are referred to as virtual cloud networks (VCNs). A customer can set up one or more virtual cloud networks (VCNs) using CI resources allocated for the customer. A VCN is a virtual or software defined private network. The customer resources that are deployed in the customer's VCN can include compute instances (e.g., virtual machines, bare-metal instances) and other resources. These compute instances may represent various customer workloads such as applications, load balancers, databases, and the like. A compute instance deployed on a VCN can communicate with publicly accessible endpoints (“public endpoints”) over a public network such as the Internet, with other instances in the same VCN or other VCNs (e.g., the customer's other VCNs, or VCNs not belonging to the customer), with the customer's on-premise data centers or networks, and with service endpoints, and other types of endpoints. CI thus offers high-performance compute resources and storage capacity in flexible virtual networks that are securely accessible from various networked locations such as from a customer's on-premises network.

The CP may provide various services using the CI. In some instances, customers of CI may themselves act like service providers and provide services using CI resources. A service provider may expose a service endpoint, which is characterized by identification information (e.g., an IP Address, a DNS name and port). A customer's resource (e.g., a compute instance) can consume a particular service by accessing a service endpoint exposed by the service for that particular service. These service endpoints are generally endpoints that are publicly accessible by users using public IP addresses associated with the endpoints via a public communication network such as the Internet. Network endpoints that are publicly accessible are also sometimes referred to as public endpoints. In certain implementations, a service endpoint provided for a service can be accessed by multiple customers that intend to consume that service. In other implementations, a dedicated service endpoint may be provided for a customer such that only that customer can access the service using that dedicated service endpoint.

In certain embodiments, when a VCN is created, it is associated with a private overlay Classless Inter-Domain Routing (CIDR) address space, which is a range of private overlay IP addresses that are assigned to the VCN (e.g., 10.0/16). A VCN includes associated subnets, route tables, and gateways. A VCN resides within a single region but can span one or more or all of the region's availability domains. A gateway is a virtual interface that is configured for a VCN and enables communication of traffic to and from the VCN to one or more endpoints outside the VCN. One or more different types of gateways may be configured for a VCN to enable communication to and from different types of endpoints.

A VCN can be subdivided into one or more sub-networks such as one or more subnets. A subnet is thus a unit of configuration or a subdivision that can be created within a VCN. A VCN can have one or multiple subnets. Each subnet within a VCN is associated with a contiguous range of overlay IP addresses (e.g., 10.0.0.0/24 and 10.0.1.0/24) that do not overlap with other subnets in that VCN, and which represent an address space subset within the address space of the VCN.

Each compute instance is associated with a virtual network interface card (VNIC), that enables the compute instance to participate in a subnet of a VCN. A VNIC is a logical representation of physical Network Interface Card (NIC). In general. a VNIC is an interface between an entity (e.g., a compute instance, a service) and a virtual network. A VNIC exists in a subnet, has one or more associated IP addresses, and associated security rules or policies. A VNIC is equivalent to a Layer-2 port on a switch. A VNIC is attached to a compute instance and to a subnet within a VCN. A VNIC associated with a compute instance enables the compute instance to be a part of a subnet of a VCN and enables the compute instance to communicate (e.g., send and receive packets) with endpoints that are on the same subnet as the compute instance, with endpoints in different subnets in the VCN, or with endpoints outside the VCN. The VNIC associated with a compute instance thus determines how the compute instance connects with endpoints inside and outside the VCN. A VNIC for a compute instance is created and associated with that compute instance when the compute instance is created and added to a subnet within a VCN. For a subnet comprising a set of compute instances, the subnet contains the VNICs corresponding to the set of compute instances, each VNIC attached to a compute instance within the set of computer instances.

Each compute instance is assigned a private overlay IP address via the VNIC associated with the compute instance. This private overlay IP address is assigned to the VNIC that is associated with the compute instance when the compute instance is created and used for routing traffic to and from the compute instance. All VNICs in a given subnet use the same route table, security lists, and DHCP options. As described above, each subnet within a VCN is associated with a contiguous range of overlay IP addresses (e.g., 10.0.0.0/24 and 10.0.1.0/24) that do not overlap with other subnets in that VCN, and which represent an address space subset within the address space of the VCN. For a VNIC on a particular subnet of a VCN, the private overlay IP address that is assigned to the VNIC is an address from the contiguous range of overlay IP addresses allocated for the subnet.

In certain embodiments, a compute instance may optionally be assigned additional overlay IP addresses in addition to the private overlay IP address, such as, for example, one or more public IP addresses if in a public subnet. These multiple addresses are assigned either on the same VNIC or over multiple VNICs that are associated with the compute instance. Each instance however has a primary VNIC that is created during instance launch and is associated with the overlay private IP address assigned to the instance—this primary VNIC cannot be removed. Additional VNICs, referred to as secondary VNICs, can be added to an existing instance in the same availability domain as the primary VNIC. All the VNICs are in the same availability domain as the instance. A secondary VNIC can be in a subnet in the same VCN as the primary VNIC, or in a different subnet that is either in the same VCN or a different one.

A compute instance may optionally be assigned a public IP address if it is in a public subnet. A subnet can be designated as either a public subnet or a private subnet at the time the subnet is created. A private subnet means that the resources (e.g., compute instances) and associated VNICs in the subnet cannot have public overlay IP addresses. A public subnet means that the resources and associated VNICs in the subnet can have public IP addresses. A customer can designate a subnet to exist either in a single availability domain or across multiple availability domains in a region or realm.

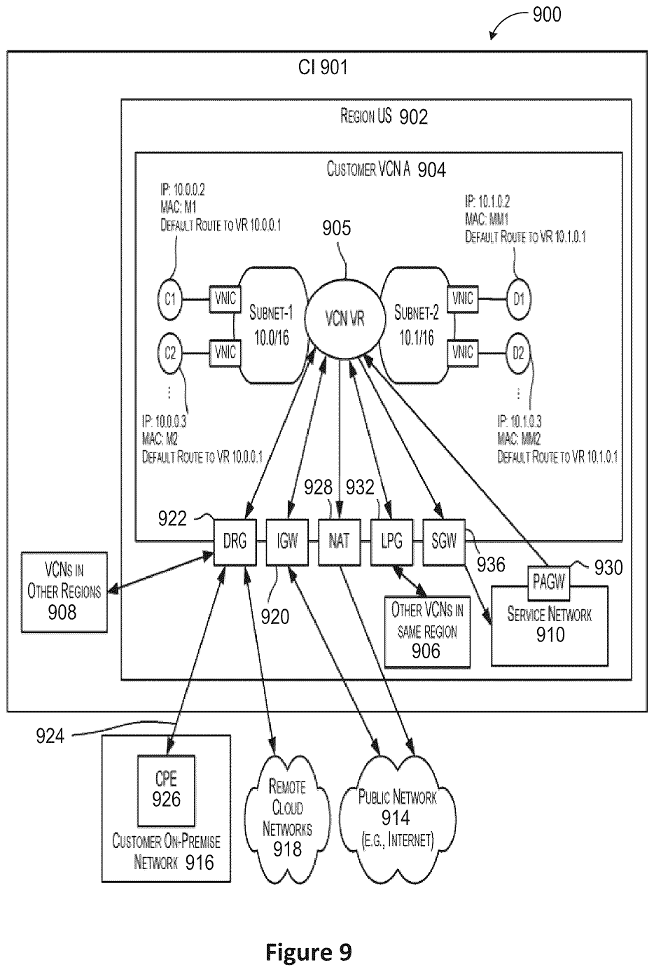

As described above, a VCN may be subdivided into one or more subnets. In certain embodiments, a Virtual Router (VR) configured for the VCN (referred to as the VCN VR or just VR) enables communications between the subnets of the VCN. For a subnet within a VCN, the VR represents a logical gateway for that subnet that enables the subnet (i.e., the compute instances on that subnet) to communicate with endpoints on other subnets within the VCN, and with other endpoints outside the VCN. The VCN VR is a logical entity that is configured to route traffic between VNICs in the VCN and virtual gateways (“gateways”) associated with the VCN. Gateways are further described below with respect to FIG. 9. A VCN VR is a Layer-3/IP Layer concept. In one embodiment, there is one VCN VR for a VCN where the VCN VR has potentially an unlimited number of ports addressed by IP addresses, with one port for each subnet of the VCN. In this manner, the VCN VR has a different IP address for each subnet in the VCN that the VCN VR is attached to. The VR is also connected to the various gateways configured for a VCN. In certain embodiments, a particular overlay IP address from the overlay IP address range for a subnet is reserved for a port of the VCN VR for that subnet. For example, consider a VCN having two subnets with associated address ranges 10.0/16 and 10.1/16, respectively. For the first subnet within the VCN with address range 10.0/16, an address from this range is reserved for a port of the VCN VR for that subnet. In some instances, the first IP address from the range may be reserved for the VCN VR. For example, for the subnet with overlay IP address range 10.0/16, IP address 10.0.0.1 may be reserved for a port of the VCN VR for that subnet. For the second subnet within the same VCN with address range 10.1/16, the VCN VR may have a port for that second subnet with IP address 10.1.0.1. The VCN VR has a different IP address for each of the subnets in the VCN.

In some other embodiments, each subnet within a VCN may have its own associated VR that is addressable by the subnet using a reserved or default IP address associated with the VR. The reserved or default IP address may, for example, be the first IP address from the range of IP addresses associated with that subnet. The VNICs in the subnet can communicate (e.g., send and receive packets) with the VR associated with the subnet using this default or reserved IP address. In such an embodiment, the VR is the ingress/egress point for that subnet. The VR associated with a subnet within the VCN can communicate with other VRs associated with other subnets within the VCN. The VRs can also communicate with gateways associated with the VCN. The VR function for a subnet is running on or executed by one or more NVDs executing VNICs functionality for VNICs in the subnet.

Route tables, security rules, and DHCP options may be configured for a VCN. Route tables are virtual route tables for the VCN and include rules to route traffic from subnets within the VCN to destinations outside the VCN by way of gateways or specially configured instances. A VCN's route tables can be customized to control how packets are forwarded/routed to and from the VCN. DHCP options refers to configuration information that is automatically provided to the instances when they boot up.

Security rules configured for a VCN represent overlay firewall rules for the VCN. The security rules can include ingress and egress rules, and specify the types of traffic (e.g., based upon protocol and port) that is allowed in and out of the instances within the VCN. The customer can choose whether a given rule is stateful or stateless. For instance, the customer can allow incoming SSH traffic from anywhere to a set of instances by setting up a stateful ingress rule with source CIDR 0.0.0.0/0, and destination TCP port 22. Security rules can be implemented using network security groups or security lists. A network security group consists of a set of security rules that apply only to the resources in that group. A security list, on the other hand, includes rules that apply to all the resources in any subnet that uses the security list. A VCN may be provided with a default security list with default security rules. DHCP options configured for a VCN provide configuration information that is automatically provided to the instances in the VCN when the instances boot up.

In certain embodiments, the configuration information for a VCN is determined and stored by a VCN Control Plane. The configuration information for a VCN may include, for example, information about the address range associated with the VCN, subnets within the VCN and associated information, one or more VRs associated with the VCN, compute instances in the VCN and associated VNICs, NVDs executing the various virtualization network functions (e.g., VNICs, VRs, gateways) associated with the VCN, state information for the VCN, and other VCN-related information. In certain embodiments, a VCN Distribution Service publishes the configuration information stored by the VCN Control Plane, or portions thereof, to the NVDs. The distributed information may be used to update information (e.g., forwarding tables, routing tables, etc.) stored and used by the NVDs to forward packets to and from the compute instances in the VCN.

In certain embodiments, the creation of VCNs and subnets are handled by a VCN Control Plane (CP), and the launching of compute instances is handled by a Compute Control Plane. The Compute Control Plane is responsible for allocating the physical resources for the compute instance and then calls the VCN Control Plane to create and attach VNICs to the compute instance. The VCN CP also sends VCN data mappings to the VCN data plane that is configured to perform packet forwarding and routing functions. In certain embodiments, the VCN CP provides a distribution service that is responsible for providing updates to the VCN data plane.

A customer may create one or more VCNs using resources hosted by CI. A compute instance deployed on a customer VCN may communicate with different endpoints. These endpoints can include endpoints that are hosted by CI and endpoints outside CI.

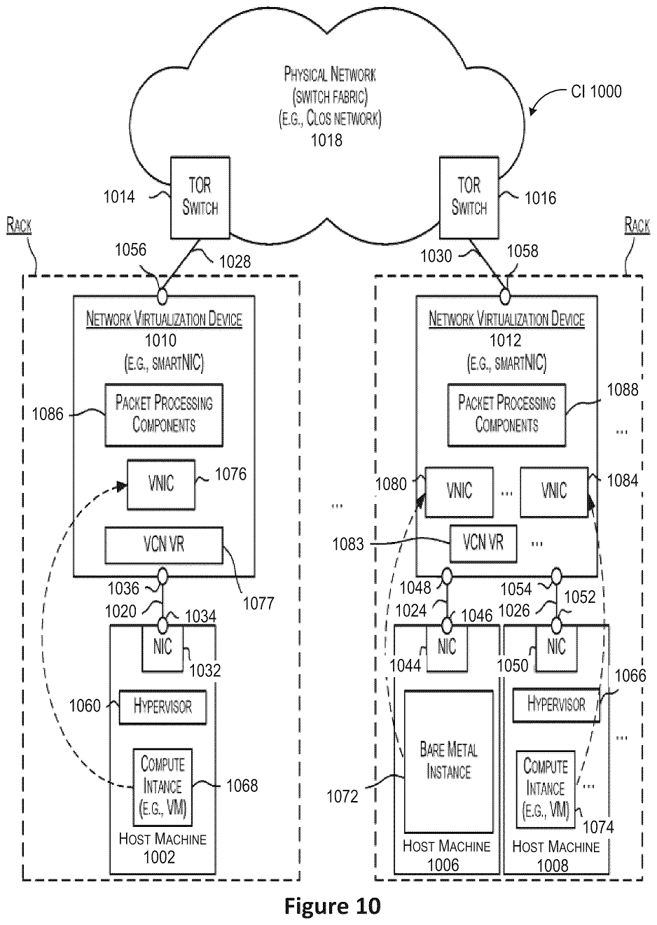

Various different architectures for implementing cloud-based service using CI are depicted in FIGS. 9 and 10, and are described below. FIG. 9 is a high-level diagram of a distributed environment 900 showing an overlay or customer VCN hosted by CI according to certain embodiments. The distributed environment depicted in FIG. 9 includes multiple components in the overlay network. Distributed environment 900 depicted in FIG. 9 is merely an example and is not intended to unduly limit the scope of claimed embodiments. Many variations, alternatives, and modifications are possible. For example, in some implementations, the distributed environment depicted in FIG. 9 may have more or fewer systems or components than those shown in FIG. 9, may combine two or more systems, or may have a different configuration or arrangement of systems.

As shown in the example depicted in FIG. 9, distributed environment 900 comprises CI 901 that provides services and resources that customers can subscribe to and use to build their virtual cloud networks (VCNs). In certain embodiments, CI 901 offers IaaS services to subscribing customers. The data centers within CI 901 may be organized into one or more regions. One example region “Region US” 902 is shown in FIG. 9. A customer has configured a customer VCN c/o Oracle International Corporation for region 902. The customer may deploy various compute instances on VCN 904, where the compute instances may include virtual machines or bare metal instances. Examples of instances include applications, database, load balancers, and the like.

In the embodiment depicted in FIG. 9, customer VCN 904 comprises two subnets, namely, “Subnet-1” and “Subnet-2”, each subnet with its own CIDR IP address range. In FIG. 9, the overlay IP address range for Subnet-1 is 10.0/16 and the address range for Subnet-2 is 10.1/16. A VCN Virtual Router 905 represents a logical gateway for the VCN that enables communications between subnets of the VCN 904, and with other endpoints outside the VCN. VCN VR 905 is configured to route traffic between VNICs in VCN 904 and gateways associated with VCN 904. VCN VR 905 provides a port for each subnet of VCN 904. For example, VR 905 may provide a port with IP address 10.0.0.1 for Subnet-1 and a port with IP address 10.1.0.1 for Subnet-2.

Multiple compute instances may be deployed on each subnet, where the compute instances can be virtual machine instances, and/or bare metal instances. The compute instances in a subnet may be hosted by one or more host machines within CI 901. A compute instance participates in a subnet via a VNIC associated with the compute instance. For example, as shown in FIG. 9, a compute instance C1 is part of Subnet-1 via a VNIC associated with the compute instance. Likewise, compute instance C2 is part of Subnet-1 via a VNIC associated with C2. In a similar manner, multiple compute instances, which may be virtual machine instances or bare metal instances, may be part of Subnet-1. Via its associated VNIC, each compute instance is assigned a private overlay IP address and a MAC address. For example, in FIG. 9, compute instance C1 has an overlay IP address of 10.0.0.2 and a MAC address of M1, while compute instance C2 has a private overlay IP address of 10.0.0.3 and a MAC address of M2. Each compute instance in Subnet-1, including compute instances C1 and C2, has a default route to VCN VR 905 using IP address 10.0.0.1, which is the IP address for a port of VCN VR 905 for Subnet-1.

Subnet-2 can have multiple compute instances deployed on it, including virtual machine instances and/or bare metal instances. For example, as shown in FIG. 9, compute instances D1 and D2 are part of Subnet-2 via VNICs associated with the respective compute instances. In the embodiment depicted in FIG. 9, compute instance D1 has an overlay IP address of 10.1.0.2 and a MAC address of MM1, while compute instance D2 has a private overlay IP address of 10.1.0.3 and a MAC address of MM2. Each compute instance in Subnet-2, including compute instances D1 and D2, has a default route to VCN VR 905 using IP address 10.1.0.1, which is the IP address for a port of VCN VR 905 for Subnet-2.

VCN A 904 may also include one or more load balancers. For example, a load balancer may be provided for a subnet and may be configured to load balance traffic across multiple compute instances on the subnet. A load balancer may also be provided to load balance traffic across subnets in the VCN.

A particular compute instance deployed on VCN 904 can communicate with various different endpoints. These endpoints may include endpoints that are hosted by CI 200 and endpoints outside CI 200. Endpoints that are hosted by CI 901 may include: an endpoint on the same subnet as the particular compute instance (e.g., communications between two compute instances in Subnet-1); an endpoint on a different subnet but within the same VCN (e.g., communication between a compute instance in Subnet-1 and a compute instance in Subnet-2); an endpoint in a different VCN in the same region (e.g., communications between a compute instance in Subnet-1 and an endpoint in a VCN in the same region 902 or 908, communications between a compute instance in Subnet-1 and an endpoint in service network 910 in the same region); or an endpoint in a VCN in a different region (e.g., communications between a compute instance in Subnet-1 and an endpoint in a VCN in a different region 902). A compute instance in a subnet hosted by CI 901 may also communicate with endpoints that are not hosted by CI 901 (i.e., are outside CI 901). These outside endpoints include endpoints in the customer's on-premises network 916, endpoints within other remote cloud networks 918, public endpoints accessible via a public network 914 such as the Internet, and other endpoints.

Communications between compute instances on the same subnet are facilitated using VNICs associated with the source compute instance and the destination compute instance. For example, compute instance C1 in Subnet-1 may want to send packets to compute instance C2 in Subnet-1. For a packet originating at a source compute instance and whose destination is another compute instance in the same subnet, the packet is first processed by the VNIC associated with the source compute instance. Processing performed by the VNIC associated with the source compute instance can include determining destination information for the packet from the packet headers, identifying any policies (e.g., security lists) configured for the VNIC associated with the source compute instance, determining a next hop for the packet, performing any packet encapsulation/decapsulation functions as needed, and then forwarding/routing the packet to the next hop with the goal of facilitating communication of the packet to its intended destination. When the destination compute instance is in the same subnet as the source compute instance, the VNIC associated with the source compute instance is configured to identify the VNIC associated with the destination compute instance and forward the packet to that VNIC for processing. The VNIC associated with the destination compute instance is then executed and forwards the packet to the destination compute instance.

For a packet to be communicated from a compute instance in a subnet to an endpoint in a different subnet in the same VCN, the communication is facilitated by the VNICs associated with the source and destination compute instances and the VCN VR. For example, if compute instance C1 in Subnet-1 in FIG. 9 wants to send a packet to compute instance D1 in Subnet-2, the packet is first processed by the VNIC associated with compute instance C1. The VNIC associated with compute instance C1 is configured to route the packet to the VCN VR 905 using default route or port 10.0.0.1 of the VCN VR. VCN VR 905 is configured to route the packet to Subnet-2 using port 10.1.0.1. The packet is then received and processed by the VNIC associated with D1 and the VNIC forwards the packet to compute instance D1.

For a packet to be communicated from a compute instance in VCN 904 to an endpoint that is outside VCN 904, the communication is facilitated by the VNIC associated with the source compute instance, VCN VR 905, and gateways associated with VCN 904. One or more types of gateways may be associated with VCN 904. A gateway is an interface between a VCN and another endpoint, where another endpoint is outside the VCN. A gateway is a Layer-3/IP layer concept and enables a VCN to communicate with endpoints outside the VCN. A gateway thus facilitates traffic flow between a VCN and other VCNs or networks. Various different types of gateways may be configured for a VCN to facilitate different types of communications with different types of endpoints. Depending upon the gateway, the communications may be over public networks (e.g., the Internet) or over private networks. Various communication protocols may be used for these communications.

For example, compute instance C1 may want to communicate with an endpoint outside VCN 904. The packet may be first processed by the VNIC associated with source compute instance C1. The VNIC processing determines that the destination for the packet is outside the Subnet-1 of C1. The VNIC associated with C1 may forward the packet to VCN VR 905 for VCN 904. VCN VR 905 then processes the packet and as part of the processing, based upon the destination for the packet, determines a particular gateway associated with VCN 904 as the next hop for the packet. VCN VR 905 may then forward the packet to the particular identified gateway. For example, if the destination is an endpoint within the customer's on-premise network, then the packet may be forwarded by VCN VR 905 to Dynamic Routing Gateway (DRG) gateway 922 configured for VCN 904. The packet may then be forwarded from the gateway to a next hop to facilitate communication of the packet to it final intended destination.

Various different types of gateways may be configured for a VCN. Examples of gateways that may be configured for a VCN are depicted in FIG. 9 and described below. As shown in the embodiment depicted in FIG. 9, a Dynamic Routing Gateway (DRG) 922 may be added to or be associated with customer VCN 904 and provides a path for private network traffic communication between customer VCN 904 and another endpoint, where another endpoint can be the customer's on-premise network 916, a VCN 908 in a different region of CI 901, or other remote cloud networks 918 not hosted by CI 901. Customer on-premise network 916 may be a customer network or a customer data center built using the customer's resources. Access to customer on-premise network 916 is generally very restricted. For a customer that has both a customer on-premise network 916 and one or more VCNs 904 deployed or hosted in the cloud by CI 901, the customer may want their on-premise network 916 and their cloud based VCN 904 to be able to communicate with each other. This enables a customer to build an extended hybrid environment encompassing the customer's VCN 904 hosted by CI 901 and their on-premises network 916. DRG 922 enables this communication. To enable such communications, a communication channel 924 is set up where one endpoint of the channel is in customer on-premise network 916 and the other endpoint is in CI 901 and connected to customer VCN 904. Communication channel 924 can be over public communication networks such as the Internet or private communication networks. Various different communication protocols may be used such as IPsec VPN technology over a public communication network such as the Internet, Oracle's FastConnect technology that uses a private network instead of a public network, and others. The device or equipment in customer on-premise network 916 that forms one end point for communication channel 924 is referred to as the customer premise equipment (CPE), such as CPE 926 depicted in FIG. 9. On the CI 901 side, the endpoint may be a host machine executing DRG 922.

In certain embodiments, a Remote Peering Connection (RPC) can be added to a DRG, which allows a customer to peer one VCN with another VCN in a different region. Using such an RPC, customer VCN 904 can use DRG 922 to connect with a VCN 908 in another region. DRG 922 may also be used to communicate with other remote cloud networks 918, not hosted by CI 901 such as a Microsoft Azure cloud, Amazon AWS cloud, and others.

As shown in FIG. 9, an Internet Gateway (IGW) 920 may be configured for customer VCN 904 the enables a compute instance on VCN 904 to communicate with public endpoints accessible over a public network 914 such as the Internet. IGW 920 is a gateway that connects a VCN to a public network such as the Internet. IGW 920 enables a public subnet (where the resources in the public subnet have public overlay IP addresses) within a VCN, such as VCN 904, direct access to public endpoints on a public network 914 such as the Internet. Using IGW 920, connections can be initiated from a subnet within VCN 904 or from the Internet.

A Network Address Translation (NAT) gateway 928 can be configured for customer's VCN 904 and enables cloud resources in the customer's VCN, which do not have dedicated public overlay IP addresses, access to the Internet and it does so without exposing those resources to direct incoming Internet connections (e.g., L4-L7 connections). This enables a private subnet within a VCN, such as private Subnet-1 in VCN 904, with private access to public endpoints on the Internet. In NAT gateways, connections can be initiated only from the private subnet to the public Internet and not from the Internet to the private subnet.

In certain embodiments, a Service Gateway (SGW) 936 can be configured for customer VCN 904 and provides a path for private network traffic between VCN 904 and supported services endpoints in a service network 910. In certain embodiments, service network 910 may be provided by the CP and may provide various services. An example of such a service network is Oracle's Services Network, which provides various services that can be used by customers. For example, a compute instance (e.g., a database system) in a private subnet of customer VCN 904 can back up data to a service endpoint (e.g., Object Storage) without needing public IP addresses or access to the Internet. In certain embodiments, a VCN can have only one SGW, and connections can only be initiated from a subnet within the VCN and not from service network 910. If a VCN is peered with another, resources in the other VCN typically cannot access the SGW. Resources in on-premises networks that are connected to a VCN with FastConnect or VPN Connect can also use the service gateway configured for that VCN.

In certain implementations, SGW 936 uses the concept of a service Classless Inter-Domain Routing (CIDR) label, which is a string that represents all the regional public IP address ranges for the service or group of services of interest. The customer uses the service CIDR label when they configure the SGW and related route rules to control traffic to the service. The customer can optionally utilize it when configuring security rules without needing to adjust them if the service's public IP addresses change in the future.

A Local Peering Gateway (LPG) 932 is a gateway that can be added to customer VCN 904 and enables VCN 904 to peer with another VCN in the same region. Peering means that the VCNs communicate using private IP addresses, without the traffic traversing a public network such as the Internet or without routing the traffic through the customer's on-premises network 916. In preferred embodiments, a VCN has a separate LPG for each peering it establishes. Local Peering or VCN Peering is a common practice used to establish network connectivity between different applications or infrastructure management functions.

Service providers, such as providers of services in service network 910, may provide access to services using different access models. According to a public access model, services may be exposed as public endpoints that are publicly accessible by compute instance in a customer VCN via a public network such as the Internet and or may be privately accessible via SGW 936. According to a specific private access model, services are made accessible as private IP endpoints in a private subnet in the customer's VCN. This is referred to as a Private Endpoint (PE) access and enables a service provider to expose their service as an instance in the customer's private network. A Private Endpoint resource represents a service within the customer's VCN. Each PE manifests as a VNIC (referred to as a PE-VNIC, with one or more private IPs) in a subnet chosen by the customer in the customer's VCN. A PE thus provides a way to present a service within a private customer VCN subnet using a VNIC. Since the endpoint is exposed as a VNIC, all the features associates with a VNIC such as routing rules, security lists, etc., are now available for the PE VNIC.

A service provider can register their service to enable access through a PE. The provider can associate policies with the service that restricts the service's visibility to the customer tenancies. A provider can register multiple services under a single virtual IP address (VIP), especially for multi-tenant services. There may be multiple such private endpoints (in multiple VCNs) that represent the same service.

Compute instances in the private subnet can then use the PE VNIC's private IP address or the service DNS name to access the service. Compute instances in the customer VCN can access the service by sending traffic to the private IP address of the PE in the customer VCN. A Private Access Gateway (PAGW) 930 is a gateway resource that can be attached to a service provider VCN (e.g., a VCN in service network 910) that acts as an ingress/egress point for all traffic from/to customer subnet private endpoints. PAGW 930 enables a provider to scale the number of PE connections without utilizing its internal IP address resources. A provider needs only configure one PAGW for any number of services registered in a single VCN. Providers can represent a service as a private endpoint in multiple VCNs of one or more customers. From the customer's perspective, the PE VNIC, which, instead of being attached to a customer's instance, appears attached to the service with which the customer wishes to interact. The traffic destined to the private endpoint is routed via PAGW 930 to the service. These are referred to as customer-to-service private connections (C2S connections).

The PE concept can also be used to extend the private access for the service to customer's on-premises networks and data centers, by allowing the traffic to flow through FastConnect/IPsec links and the private endpoint in the customer VCN. Private access for the service can also be extended to the customer's peered VCNs, by allowing the traffic to flow between LPG 932 and the PE in the customer's VCN.

A customer can control routing in a VCN at the subnet level, so the customer can specify which subnets in the customer's VCN, such as VCN 904, use each gateway. A VCN's route tables are used to decide if traffic is allowed out of a VCN through a particular gateway. For example, in a particular instance, a route table for a public subnet within customer VCN 904 may send non-local traffic through IGW 920. The route table for a private subnet within the same customer VCN 904 may send traffic destined for CP services through SGW 936. All remaining traffic may be sent via the NAT gateway 928. Route tables only control traffic going out of a VCN.

Security lists associated with a VCN are used to control traffic that comes into a VCN via a gateway via inbound connections. All resources in a subnet use the same route table and security lists. Security lists may be used to control specific types of traffic allowed in and out of instances in a subnet of a VCN. Security list rules may comprise ingress (inbound) and egress (outbound) rules. For example, an ingress rule may specify an allowed source address range, while an egress rule may specify an allowed destination address range. Security rules may specify a particular protocol (e.g., TCP, ICMP), a particular port (e.g., 22 for SSH, 3389 for Windows RDP), etc. In certain implementations, an instance's operating system may enforce its own firewall rules that are aligned with the security list rules. Rules may be stateful (e.g., a connection is tracked, and the response is automatically allowed without an explicit security list rule for the response traffic) or stateless.

Access from a customer VCN (i.e., by a resource or compute instance deployed on VCN 904) can be categorized as public access, private access, or dedicated access. Public access refers to an access model where a public IP address or a NAT is used to access a public endpoint. Private access enables customer workloads in VCN 904 with private IP addresses (e.g., resources in a private subnet) to access services without traversing a public network such as the Internet. In certain embodiments, CI 901 enables customer VCN workloads with private IP addresses to access the (public service endpoints of) services using a service gateway. A service gateway thus offers a private access model by establishing a virtual link between the customer's VCN and the service's public endpoint residing outside the customer's private network.

Additionally, CI may offer dedicated public access using technologies such as FastConnect public peering where customer on-premises instances can access one or more services in a customer VCN using a FastConnect connection and without traversing a public network such as the Internet. CI also may also offer dedicated private access using FastConnect private peering where customer on-premises instances with private IP addresses can access the customer's VCN workloads using a FastConnect connection. FastConnect is a network connectivity alternative to using the public Internet to connect a customer's on-premise network to CI and its services. FastConnect provides an easy, elastic, and economical way to create a dedicated and private connection with higher bandwidth options and a more reliable and consistent networking experience when compared to Internet-based connections.

FIG. 9 and the accompanying description above describes various virtualized components in an example virtual network. As described above, the virtual network is built on the underlying physical or substrate network. FIG. 10 depicts a simplified architectural diagram of the physical components in the physical network within CI 1000 that provide the underlay for the virtual network according to certain embodiments. As shown, CI 1000 provides a distributed environment comprising components and resources (e.g., compute, memory, and networking resources) provided by a cloud service provider (CP). These components and resources are used to provide cloud services (e.g., IaaS services) to subscribing customers, i.e., customers that have subscribed to one or more services provided by the CP. Based upon the services subscribed to by a customer, a subset of resources (e.g., compute, memory, and networking resources) of CI 1000 are provisioned for the customer. Customers can then build their own cloud-based (i.e., CI-hosted) customizable and private virtual networks using physical compute, memory, and networking resources provided by CI 1000. As previously indicated, these customer networks are referred to as virtual cloud networks (VCNs). A customer can deploy one or more customer resources, such as compute instances, on these customer VCNs. Compute instances can be in the form of virtual machines, bare metal instances, and the like. CI 1000 provides infrastructure and a set of complementary cloud services that enable customers to build and run a wide range of applications and services in a highly available hosted environment.

In the example embodiment depicted in FIG. 10, the physical components of CI 1000 include one or more physical host machines or physical servers (e.g., 1002, 1006, 1008), network virtualization devices (NVDs) (e.g., 1010, 1012), top-of-rack (TOR) switches (e.g., 1014, 1016), and a physical network (e.g., 1018), and switches in physical network 1018. The physical host machines or servers may host and execute various compute instances that participate in one or more subnets of a VCN. The compute instances may include virtual machine instances, and bare metal instances. For example, the various compute instances depicted in FIG. 9 may be hosted by the physical host machines depicted in FIG. 10. The virtual machine compute instances in a VCN may be executed by one host machine or by multiple different host machines. The physical host machines may also host virtual host machines, container-based hosts or functions, and the like. The VNICs and VCN VR depicted in FIG. 9 may be executed by the NVDs depicted in FIG. 10. The gateways depicted in FIG. 9 may be executed by the host machines and/or by the NVDs depicted in FIG. 10.

The host machines or servers may execute a hypervisor (also referred to as a virtual machine monitor or VMM) that creates and enables a virtualized environment on the host machines. The virtualization or virtualized environment facilitates cloud-based computing. One or more compute instances may be created, executed, and managed on a host machine by a hypervisor on that host machine. The hypervisor on a host machine enables the physical computing resources of the host machine (e.g., compute, memory, and networking resources) to be shared between the various compute instances executed by the host machine.

For example, as depicted in FIG. 10, host machines 1002 and 1008 execute hypervisors 1060 and 1066, respectively. These hypervisors may be implemented using software, firmware, or hardware, or combinations thereof. Typically, a hypervisor is a process or a software layer that sits on top of the host machine's operating system (OS), which in turn executes on the hardware processors of the host machine. The hypervisor provides a virtualized environment by enabling the physical computing resources (e.g., processing resources such as processors/cores, memory resources, networking resources) of the host machine to be shared among the various virtual machine compute instances executed by the host machine. For example, in FIG. 10, hypervisor 1060 may sit on top of the OS of host machine 1002 and enables the computing resources (e.g., processing, memory, and networking resources) of host machine 1002 to be shared between compute instances (e.g., virtual machines) executed by host machine 1002. A virtual machine can have its own operating system (referred to as a guest operating system), which may be the same as or different from the OS of the host machine. The operating system of a virtual machine executed by a host machine may be the same as or different from the operating system of another virtual machine executed by the same host machine. A hypervisor thus enables multiple operating systems to be executed alongside each other while sharing the same computing resources of the host machine. The host machines depicted in FIG. 10 may have the same or different types of hypervisors.

A compute instance can be a virtual machine instance or a bare metal instance. In FIG. 10, compute instances 1068 on host machine 1002 and compute instance 1074 on host machine 1008 are examples of virtual machine instances. Host machine 1006 is an example of a bare metal instance that is provided to a customer.

In certain instances, an entire host machine may be provisioned to a single customer, and all of the one or more compute instances (either virtual machines or bare metal instance) hosted by that host machine belong to that same customer. In other instances, a host machine may be shared between multiple customers (i.e., multiple tenants). In such a multi-tenancy scenario, a host machine may host virtual machine compute instances belonging to different customers. These compute instances may be members of different VCNs of different customers. In certain embodiments, a bare metal compute instance is hosted by a bare metal server without a hypervisor. When a bare metal compute instance is provisioned, a single customer or tenant maintains control of the physical CPU, memory, and network interfaces of the host machine hosting the bare metal instance and the host machine is not shared with other customers or tenants.

As previously described, each compute instance that is part of a VCN is associated with a VNIC that enables the compute instance to become a member of a subnet of the VCN. The VNIC associated with a compute instance facilitates the communication of packets or frames to and from the compute instance. A VNIC is associated with a compute instance when the compute instance is created. In certain embodiments, for a compute instance executed by a host machine, the VNIC associated with that compute instance is executed by an NVD connected to the host machine. For example, in FIG. 10, host machine 1002 executes a virtual machine compute instance 1068 that is associated with VNIC 1076, and VNIC 1076 is executed by NVD 1010 connected to host machine 1002. As another example, bare metal instance 1072 hosted by host machine 1006 is associated with VNIC 1080 that is executed by NVD 1012 connected to host machine 1006. As yet another example, VNIC 1084 is associated with compute instance 1074 executed by host machine 1008, and VNIC 1084 is executed by NVD 1012 connected to host machine 1008.

For compute instances hosted by a host machine, an NVD connected to that host machine also executes VCN VRs corresponding to VCNs of which the compute instances are members. For example, in the embodiment depicted in FIG. 10, NVD 1010 executes VCN VR 1077 corresponding to the VCN of which compute instance 1068 is a member. NVD 1012 may also execute one or more VCN VRs 1083 corresponding to VCNs corresponding to the compute instances hosted by host machines 1006 and 1008.

A host machine may include one or more network interface cards (NIC) that enable the host machine to be connected to other devices. A NIC on a host machine may provide one or more ports (or interfaces) that enable the host machine to be communicatively connected to another device. For example, a host machine may be connected to an NVD using one or more ports (or interfaces) provided on the host machine and on the NVD. A host machine may also be connected to other devices such as another host machine.

For example, in FIG. 10, host machine 1002 is connected to NVD 1010 using link 1020 that extends between a port 1034 provided by a NIC 1032 of host machine 1002 and between a port 1036 of NVD 1010. Host machine 1006 is connected to NVD 1012 using link 1024 that extends between a port 1046 provided by a NIC 1044 of host machine 1006 and between a port 1048 of NVD 1012. Host machine 1008 is connected to NVD 1012 using link 1026 that extends between a port 1052 provided by a NIC 1050 of host machine 1008 and between a port 1054 of NVD 1012.

The NVDs are in turn connected via communication links to top-of-the-rack (TOR) switches, which are connected to physical network 1018 (also referred to as the switch fabric). In certain embodiments, the links between a host machine and an NVD, and between an NVD and a TOR switch are Ethernet links. For example, in FIG. 10, NVDs 1010 and 1012 are connected to TOR switches 1014 and 1016, respectively, using links 1028 and 1030. In certain embodiments, the links 1020, 1024, 1026, 1028, and 1030 are Ethernet links. The collection of host machines and NVDs that are connected to a TOR is sometimes referred to as a rack.

Physical network 1018 provides a communication fabric that enables TOR switches to communicate with each other. A communication fabric, also called network fabric or fabric, refers to a physical network structure that includes a set of interconnected switches that provide multiple redundant pathways for data flow between a set of computing devices. A fabric enables high-throughput, low-latency communication through structured, multi-path routing. A fabric has a topology that defines a physical layout and arrangement of the set of interconnected switches and links. The physical layout and arrangement of the set of interconnected switches and links define pathways for data to flow across the fabric. In an embodiment, physical network 1018 can be a multi-tiered network. In certain implementations, physical network 1018 is a multi-tiered Clos network of switches, with TOR switches 1014 and 1016 representing the leaf level nodes of the multi-tiered and multi-node physical switching network 1018. Example network fabrics employing different network topologies, such as a Clos topology, are further described below in Section 6, titled “Example Network Fabrics.”

### 6. Example Network Fabrics

Computing components located in the various racks of a data center are interconnected to one another by fabric. The term “network fabric” or “fabric” generally refers to a physical network structure that includes a set of interconnected switches that provide multiple redundant pathways for data flow between a set of computing devices. A fabric enables high-throughput, low-latency communication through structured, multi-path routing.

A fabric is associated with a topology that defines a physical layout and arrangement of the set of interconnected switches and links. The physical layout and arrangement of the set of interconnected switches and links define pathways for data to flow across the fabric. An example network topology is multi-tiered Clos topology. A multi-tiered Clos topology is a type of non-blocking, multistage or multi-tiered switching network topology, where the number of stages or tiers can be two, three, four, five, etc. A Clos network with “n” stages may be referred to as a “n”-tiered network. Each switch in “tier n” is connected to each switch in “tier n+1.” In a 2-tier spine, t1 may be referred to a leaf layer, and t2 may be referred to as a spine layer. The spine layer can server as a high-speed backbone, interacting with the leaf layer.

A fabric can include different groups of switches and clients, referred to as “fabric groups” and “client groups,” arranged in various variations or arrangements of network topologies. Each tier of the fabric includes one or more fabric groups. The leaf tier includes one or more client groups (e.g., computing servers, GPU servers, and/or end devices). A “role” of a fabric group is associated with the tier of the fabric group. For example, a role of a fabric group in t1 may be “leaf”; and a role of a fabric group in t2 may be “spine.”

Each fabric group has a defined number of switches. Each switch has one or more south-facing ports, also called “downlinks,” and one or more north-facing ports, also called “uplinks.” The south-facing ports of switches in a fabric group of an upper tier may be connected to the north-facing ports of switches in a fabric group of a lower tier.

The configuration of connections between switches of fabric groups of adjacent tiers may be referred to as “linking configurations” or “linking rules.” Examples of linking configurations include a full mesh configuration, or a partial mesh configuration. In a full mesh configuration, every south-facing port of switches of an upper fabric group is directly connected to every north-facing port of switches of a lower fabric group. The non-blocking configuration allows connections to be made between switches in adjacent tiers without interference from currently established connections. Various cablings options may be used to implement the links, such as Active Optical Connectors (AOCs); high-speed optical transceivers that uses Coarse Wavelength Division Multiplexing (CWDM); and/or high-speed, hot-pluggable, low-power-dissipation optical transceivers.

FIG. 11 depicts a simplified block diagram of a physical network 1100 structured as a Clos network according to certain embodiments. The embodiment depicted in FIG. 11 is a 3-tiered network comprising tiers 1, 2, and 3. The TOR switches represent Tier-0 switches in the Clos network. One or more NVDs are connected to the TOR switches. Tier-0 switches are also referred to as edge devices of the physical network. The Tier-0 switches are connected to Tier-1 switches (also referred to as leaf switches). In the embodiment depicted in FIG. 11, a set of “n” Tier-0 TOR switches are connected to a set of “n” Tier-1 switches and together form a pod. Each Tier-0 switch in a pod is interconnected to all the Tier-1 switches in the pod, but there is no connectivity of switches between pods. In certain implementations, two pods are referred to as a block. Each block is served by or connected to a set of “n” Tier-2 switches (sometimes referred to as spine switches). There can be several blocks in the physical network topology. The Tier-2 switches are in turn connected to “n” Tier-3 switches (sometimes referred to as super-spine switches). Communication of packets over physical network 1100 is typically performed using one or more Layer-3 communication protocols. Typically, all the layers of the physical network, except for the TORs layer are n-ways redundant thus allowing for high availability. Policies may be specified for pods and blocks to control the visibility of switches to each other in the physical network so as to enable scaling of the physical network.

A feature of a Clos network is that the maximum hop count to reach from one Tier-0 switch to another Tier-0 switch (or from an NVD connected to a Tier-0-switch to another NVD connected to a Tier-0 switch) is fixed. For example, in a 3-Tiered Clos network at most seven hops are needed for a packet to reach from one NVD to another NVD, where the source and target NVDs are connected to the leaf tier of the Clos network. Likewise, in a 4-tiered Clos network, at most nine hops are needed for a packet to reach from one NVD to another NVD, where the source and target NVDs are connected to the leaf tier of the Clos network. Thus, a Clos network architecture maintains consistent latency throughout the network, which is important for communication within and between data centers. A Clos topology scales horizontally and is cost effective. The bandwidth/throughput capacity of the network can be easily increased by adding more switches at the various tiers (e.g., more leaf and spine switches) and by increasing the number of links between the switches at adjacent tiers.

In an embodiment, a single site implements multiple networks, each implemented by one or more network fabrics. Each network in a site may serve a different purpose, such as a front-end network, a back-end network, a management network, and/or other networks. Each network fabric in a site may be implemented using a different network topology or a different combination of network topologies.

As examples, a compute network fabric architecture (CNFA) is configured to connect with non-network racks (compute, storage, service enclave, etc.) within a datacenter. CNFA may be implemented as a 3-tier Clos network. A junction network fabric architecture (JNFA) is configured to connect with network device roles, including: CNFAs; internet gateways; dedicated private connections to on-premise datacenters of customers; and backbone devices. JNFA may be implemented as a 2-tier Clos network. A management network fabric architecture (MNFA) is configured to connect with management devices. In an example, a site includes a CNFA, JNDA, and MNFA. The CNFA may include multiple (e.g., six) blocks. For external connectivity, a subset of t2 blocks (e.g., one t2 block) of the CNFA in a site is dedicated to connecting to t1 switches of the JNFA (rather than t3 super-spine switches of the CNFA, as described above). Further, one or more t1 switches of the JNFA are dedicated to connecting to t1 switches of the MNFA.

As further examples, performance network fabric architectures (PNFA) may be used. PNFA provides connectivity for cluster networks, such as high-performance computer (HPC) networks, high-performance database platform networks, and GPU networks. PNFA enables fine-grained traffic engineering that supports Quality of Service (QoS), which is a set of technologies that manage network traffic to prioritize critical applications. PNFA supports RDMA over Converged Ethernet (e.g., RoCE v1 and/or ROCEv2), Virtual eXtensible Local-Area Network (VXLAN), dynamic load balancing (DLB), Dot1x, etc. Different variants of PNFA have different numbers of tiers, e.g., two, three. In an example, a site may include a CNFA and a PNFA. “RDMA” or “Remote Direct Memory Access” generally refers to a technology that allows computing devices to access each other's memory directly without using the operating system.

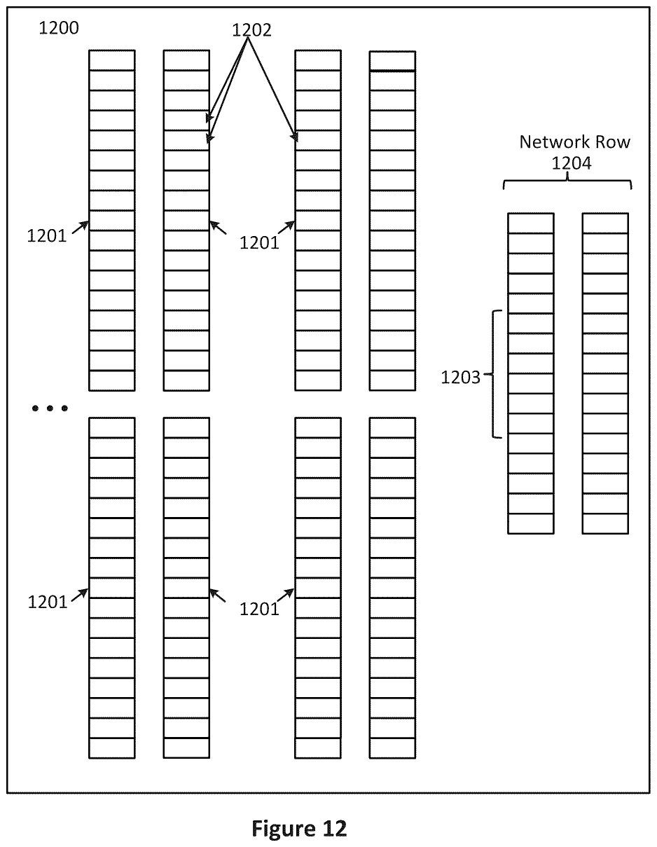

A fabric topology is implemented by physical racks of switches. In an embodiment, each block of switches in a network fabric is implemented in separate racks within a datacenter. FIG. 12 depicts a data hall 1200 containing rows of compute racks and network racks, with the network racks implementing a network fabric, according to certain embodiments. The leaf block racks 1201 may be located on the data hall floor adjacent to host-containing racks 1202, effectively providing the data hall with functionality of an intermediate distribution frame (IDF). The spine block racks 1203 may be located in a network row 1204 in the data hall 1200, effectively providing the data hall with functionality of a main distribution frame (MDF). Several data halls can be combined to provide a data center with a larger capacity.

### 7. Example Machine Learning System

### A. Example Architecture of a Machine Learning System

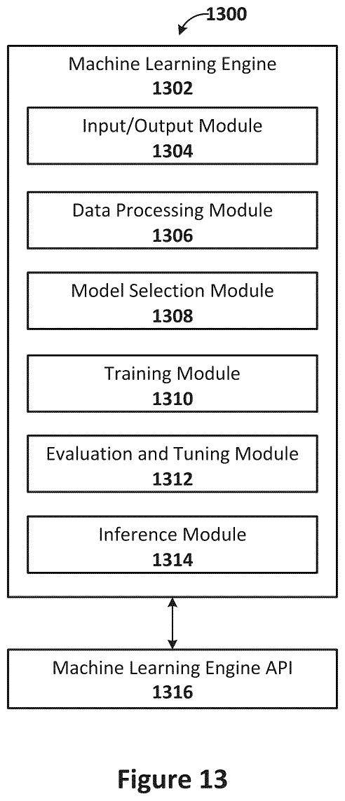

FIG. 13 illustrates an example architecture of a machine learning system 1300. The machine learning system 1300 includes a machine learning engine 1302 in accordance with one or more embodiments. As illustrated in FIG. 13, machine learning engine 1302 includes input/output module 1304, data preprocessing module 1306, model selection module 1308, training module 1310, evaluation and tuning module 1312, and inference module 1314.

In accordance with an embodiment, input/output module 1304 serves as the primary interface for data entering and exiting the system, managing the flow and integrity of data. This module may accommodate a wide range of data sources and formats to facilitate integration and communication within the machine learning architecture.

In an embodiment, an input handler within input/output module 1304 includes a data ingestion framework capable of interfacing with various data sources, such as databases, APIs, file systems, and real-time data streams. This framework is equipped with functionalities to handle different data formats (e.g., CSV, JSON, XML) and efficiently manage large volumes of data. It includes mechanisms for batch and real-time data processing that enable the input/output module 1304 to be versatile in different operational contexts, whether processing historical datasets or streaming data.

In accordance with an embodiment, input/output module 1304 manages data integrity and quality as it enters the system by incorporating initial checks and validations. These checks and validations ensure that incoming data meets predefined quality standards, like checking for missing values, ensuring consistency in data formats, and verifying data ranges and types. This proactive approach to data quality minimizes potential errors and inconsistencies in later stages of the machine learning process.

In an embodiment, an output handler within input/output module 1304 includes an output framework designed to handle the distribution and exportation of outputs, predictions, or insights. Using the output framework, input/output module 1304 formats these outputs into user-friendly and accessible formats, such as reports, visualizations, or data files compatible with other systems. Input/output module 1304 also ensures secure and efficient transmission of these outputs to end-users or other systems in an embodiment and may employ encryption and secure data transfer protocols to maintain data confidentiality.

In accordance with an embodiment, data preprocessing module 1306 transforms data into a format suitable for use by other modules in machine learning engine 1302. For example, data preprocessing module 1306 may transform raw data into a normalized or standardized format suitable for training ML models and for processing new data inputs for inference. In an embodiment, data preprocessing module 1306 acts as a bridge between the raw data sources and the analytical capabilities of machine learning engine 1302.

In an embodiment, data preprocessing module 1306 begins by implementing a series of preprocessing steps to clean, normalize, and/or standardize the data. This involves handling a variety of anomalies, such as managing unexpected data elements, recognizing inconsistencies, or dealing with missing values. Some of these anomalies can be addressed through methods like imputation or removal of incomplete records, depending on the nature and volume of the missing data. Data preprocessing module 1306 may be configured to handle anomalies in different ways depending on context. Data preprocessing module 1306 also handles the normalization of numerical data in preparation for use with models sensitive to the scale of the data, like neural networks and distance-based algorithms. Normalization techniques, such as min-max scaling or z-score standardization, may be applied to bring numerical features to a common scale, enhancing the model's ability to learn effectively.

In an embodiment, data preprocessing module 1306 includes a feature encoding framework that ensures categorical variables are transformed into a format that can be easily interpreted by machine learning algorithms. Techniques like one-hot encoding or label encoding may be employed to convert categorical data into numerical values, making them suitable for analysis. The module may also include feature selection mechanisms, where redundant or irrelevant features are identified and removed, thereby increasing the efficiency and performance of the model.

In accordance with an embodiment, when data preprocessing module 1306 processes new data for inference, data preprocessing module 1306 replicates the same preprocessing steps to ensure consistency with the training data format. This helps to avoid discrepancies between the training data format and the inference data format, thereby reducing the likelihood of inaccurate or invalid model predictions.

In an embodiment, model selection module 1308 includes logic for determining the most suitable algorithm or model architecture for a given dataset and problem. This module operates in part by analyzing the characteristics of the input data, such as its dimensionality, distribution, and the type of problem (classification, regression, clustering, etc.).

In an embodiment, model selection module 1308 employs a variety of statistical and analytical techniques to understand data patterns, identify potential correlations, and assess the complexity of the task. Based on this analysis, it then matches the data characteristics with the strengths and weaknesses of various available models. This can range from simple linear models for less complex problems to sophisticated deep learning architectures for tasks requiring feature extraction and high-level pattern recognition, such as image and speech recognition.

In an embodiment, model selection module 1308 utilizes techniques from the field of Automated Machine Learning (AutoML). AutoML systems automate the process of model selection by rapidly prototyping and evaluating multiple models. They use techniques like Bayesian optimization, genetic algorithms, or reinforcement learning to explore the model space efficiently. Model selection module 1308 may use these techniques to evaluate each candidate model based on performance metrics relevant to the task. For example, accuracy, precision, recall, or F1 score may be used for classification tasks and mean squared error metrics may be used for regression tasks. Accuracy measures the proportion of correct predictions (both positive and negative). Precision measures the proportion of actual positives among the predicted positive cases. Recall (also known as sensitivity) evaluates how well the model identifies actual positives. F1 Score is a single metric that accounts for both false positives and false negatives. The mean squared error (MSE) metric may be used for regression tasks. MSE measures the average squared difference between the actual and predicted values, providing an indication of the model's accuracy. A lower MSE may indicate a model's greater accuracy in predicting values, as it represents a smaller average discrepancy between the actual and predicted values.

In accordance with an embodiment, model selection module 1308 also considers computational efficiency and resource constraints. This is meant to help ensure the selected model is both accurate and practical in terms of computational and time requirements. In an embodiment, certain features of model selection module 1308 are configurable such as a configured bias toward (or against) computational efficiency.

In accordance with an embodiment, training module 1310 manages the ‘learning’ process of ML models by implementing various learning algorithms that enable models to identify patterns and make predictions or decisions based on input data. In an embodiment, the training process begins with the preparation of the dataset after preprocessing; this involves splitting the data into training and validation sets. The training set is used to teach the model, while the validation set is used to evaluate its performance and adjust parameters accordingly. Training module 1310 handles the iterative process of feeding the training data into the model, adjusting the model's internal parameters (like weights in neural networks) through backpropagation and optimization algorithms, such as stochastic gradient descent or other algorithms providing similarly useful results.

In accordance with an embodiment, training module 1310 manages overfitting, where a model learns the training data too well, including its noise and outliers, at the expense of its ability to generalize to new data. Techniques such as regularization, dropout (in neural networks), and early stopping are implemented to mitigate this. Additionally, the module employs various techniques for hyperparameter tuning; this involves adjusting model parameters that are not directly learned from the training process, such as learning rate, the number of layers in a neural network, or the number of trees in a random forest.

In an embodiment, training module 1310 includes logic to handle different types of data and learning tasks. For instance, it includes different training routines for supervised learning (where the training data comes with labels) and unsupervised learning (without labeled data). In the case of deep learning models, training module 1310 also manages the complexities of training neural networks that include initializing network weights, choosing activation functions, and setting up neural network layers.

In an embodiment, evaluation and tuning module 1312 incorporates dynamic feedback mechanisms and facilitates continuous model evolution to help ensure the system's relevance and accuracy as the data landscape changes. Evaluation and tuning module 1312 conducts a detailed evaluation of a model's performance. This process involves using statistical methods and a variety of performance metrics to analyze the model's predictions against a validation dataset. The validation dataset, distinct from the training set, is instrumental in assessing the model's predictive accuracy and its capacity to generalize beyond the training data. The module's algorithms meticulously dissect the model's output, uncovering biases, variances, and the overall effectiveness of the model in capturing the underlying patterns of the data.

In an embodiment, evaluation and tuning module 1312 performs continuous model tuning by using hyperparameter optimization. Evaluation and tuning module 1312 performs an exploration of the hyperparameter space using algorithms, such as grid search, random search, or more sophisticated methods like Bayesian optimization. Evaluation and tuning module 1312 uses these algorithms to iteratively adjust and refine the model's hyperparameters—settings that govern the model's learning process but are not directly learned from the data—to enhance the model's performance. This tuning process helps to balance the model's complexity with its ability to generalize and attempts to avoid the pitfalls of underfitting or overfitting.

In an embodiment, evaluation and tuning module 1312 integrates data feedback and updates the model. Evaluation and tuning module 1312 actively collects feedback from the model's real-world applications, an indicator of the model's performance in practical scenarios. Such feedback can come from various sources depending on the nature of the application. For example, in a user-centric application like a recommendation system, feedback might comprise user interactions, preferences, and responses. In other contexts, such as predicting events, it might involve analyzing the model's prediction errors, misclassifications, or other performance metrics in live environments.

In an embodiment, feedback integration logic within evaluation and tuning module 1312 integrates this feedback using a process of assimilating new data patterns, user interactions, and error trends into the system's knowledge base. The feedback integration logic uses this information to identify shifts in data trends or emergent patterns that were not present or inadequately represented in the original training dataset. Based on this analysis, the module triggers a retraining or updating cycle for the model. If the feedback suggests minor deviations or incremental changes in data patterns, the feedback integration logic may employ incremental learning strategies, fine-tuning the model with the new data while retaining its previously learned knowledge. In cases where the feedback indicates significant shifts or the emergence of new patterns, a more comprehensive model updating process may be initiated. This process might involve revisiting the model selection process, re-evaluating the suitability of the current model architecture, and/or potentially exploring alternative models or configurations that are more attuned to the new data.

In accordance with an embodiment, throughout this iterative process of feedback integration and model updating, evaluation and tuning module 1312 employs version control mechanisms to track changes, modifications, and the evolution of the model, facilitating transparency and allowing for rollback if necessary. This continuous learning and adaptation cycle, driven by real-world data and feedback, helps to endure the model's ongoing effectiveness, relevance, and accuracy.

In an embodiment, inference module 1314 transforms data raw data into actionable, precise, and contextually relevant predictions. In addition to processing and applying a trained model to new data, inference module 1314 may also include post-processing logic that refines the raw outputs of the model into meaningful insights.

In an embodiment, inference module 1314 includes classification logic that takes the probabilistic outputs of the model and converts them into definitive class labels. This process involves an analytical interpretation of the probability distribution for each class. For example, in binary classification, the classification logic may identify the class with a probability above a certain threshold, but classification logic may also consider the relative probability distribution between classes to create a more nuanced and accurate classification.

In an embodiment, inference module 1314 transforms the outputs of a trained model into definitive classifications. Inference module 1314 employs the underlying model as a tool to generate probabilistic outputs for each potential class. It then engages in an interpretative process to convert these probabilities into concrete class labels.

In an embodiment, when inference module 1314 receives the probabilistic outputs from the model, it analyzes these probabilities to determine how they are distributed across some or every potential class. If the highest probability is not significantly greater than the others, inference module 1314 may determine that there is ambiguity or interpret this as a lack of confidence displayed by the model.

In an embodiment, inference module 1314 uses thresholding techniques for applications where making a definitive decision based on the highest probability might not suffice due to the critical nature of the decision. In such cases, inference module 1314 assesses if the highest probability surpasses a certain confidence threshold that is predetermined based on the specific requirements of the application. If the probabilities do not meet this threshold, inference module 1314 may flag the result as uncertain or defer the decision to a human expert. Inference module 1314 dynamically adjusts the decision thresholds based on the sensitivity and specificity requirements of the application, subject to calibration for balancing the trade-offs between false positives and false negatives.

In accordance with an embodiment, inference module 1314 contextualizes the probability distribution against the backdrop of the specific application. This involves a comparative analysis, especially in instances where multiple classes have similar probability scores, to deduce the most plausible classification. In an embodiment, inference module 1314 may incorporate additional decision-making rules or contextual information to guide this analysis, ensuring that the classification aligns with the practical and contextual nuances of the application.

In regression models, where the outputs are continuous values, inference module 1314 may engage in a detailed scaling process in an embodiment. Outputs, often normalized or standardized during training for optimal model performance, are rescaled back to their original range. This rescaling involves recalibration of the output values using the original data's statistical parameters, such as mean and standard deviation, ensuring that the predictions are meaningful and comparable to the real-world scales they represent.

In an embodiment, inference module 1314 incorporates domain-specific adjustments into its post-processing routine. This involves tailoring the model's output to align with specific industry knowledge or contextual information. For example, in financial forecasting, inference module 1314 may adjust predictions based on current market trends, economic indicators, or recent significant events, ensuring that the outputs are both statistically accurate and practically relevant.

In an embodiment, inference module 1314 includes logic to handle uncertainty and ambiguity in the model's predictions. In cases where inference module 1314 outputs a measure of uncertainty, such as in Bayesian inference models, inference module 1314 interprets these uncertainty measures by converting probabilistic distributions or confidence intervals into a format that can be easily understood and acted upon. This provides users with both a prediction and an insight into the confidence level of that prediction. In an embodiment, inference module 1314 includes mechanisms for involving human oversight or integrating the instance into a feedback loop for subsequent analysis and model refinement.

In an embodiment, inference module 1314 formats the final predictions for end-user consumption. Predictions are converted into visualizations, user-friendly reports, or interactive interfaces. In some systems, like recommendation engines, inference module 1314 also integrates feedback mechanisms, where user responses to the predictions are used to continually refine and improve the model, creating a dynamic, self-improving system.

### B. Example Operations of a Machine Learning System

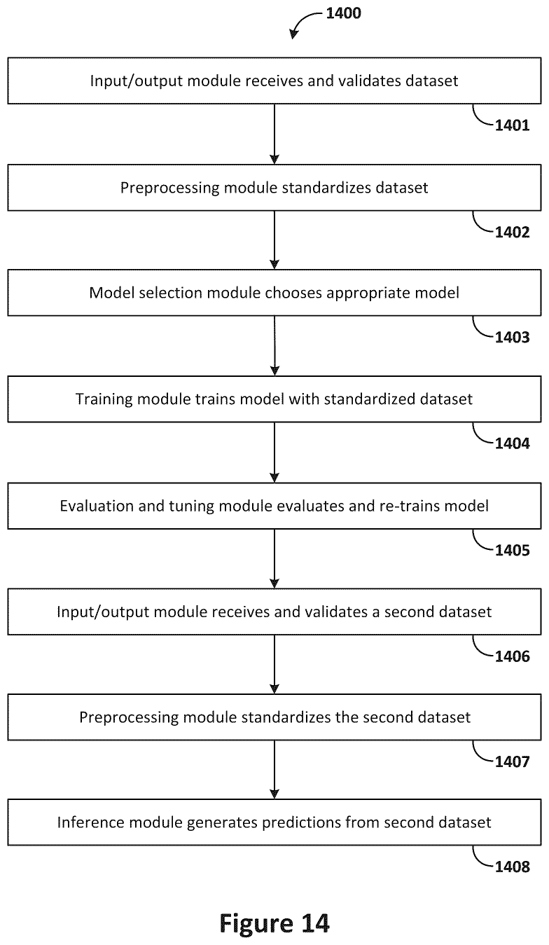

FIG. 14 illustrates example operations 1400 of a machine learning system in one or more embodiments. In an embodiment, input/output module 1304 receives a dataset intended for training (Operation 1401). This data can originate from diverse sources, like databases or real-time data streams, and in varied formats, such as CSV, JSON, or XML. Input/output module 1304 assesses and validates the data, ensuring its integrity by checking for consistency, data ranges, and types.

In an embodiment, training data is passed to data preprocessing module 1306. Here, the data undergoes a series of transformations to standardize and clean it, making it suitable for training ML models (Operation 1402). This involves normalizing numerical data, encoding categorical variables, and handling missing values through techniques like imputation.

In an embodiment, prepared data from the data preprocessing module 1306 is then fed into model selection module 1308 (Operation 1403). This module analyzes the characteristics of the processed data, such as dimensionality and distribution, and selects the most appropriate model architecture for the given dataset and problem. It employs statistical and analytical techniques to match the data with an optimal model, ranging from simpler models for less complex tasks to more advanced architectures for intricate tasks.

In an embodiment, training module 1310 trains the selected model with the prepared dataset (Operation 1404). It implements learning algorithms to adjust the model's internal parameters, optimizing them to identify patterns and relationships in the training data. Training module 1310 also addresses the challenge of overfitting by implementing techniques, like regularization and early stopping, ensuring the model's generalizability.

In an embodiment, evaluation and tuning module 1312 evaluates the trained model's performance using the validation dataset (Operation 1405). Evaluation and tuning module 1312 applies various metrics to assess predictive accuracy and generalization capabilities. It then tunes the model by adjusting hyperparameters, and if needed, incorporates feedback from the model's initial deployments, retraining the model with new data patterns identified from the feedback.

In an embodiment, input/output module 1304 receives a dataset intended for inference. Input/output module 1304 assesses and validates the data (Operation 1406).

In an embodiment, data preprocessing module 1306 receives the validated dataset intended for inference (Operation 1407). Data preprocessing module 1306 ensures that the data format used in training is replicated for the new inference data, maintaining consistency and accuracy for the model's predictions.

In an embodiment, inference module 1314 processes the new data set intended for inference, using the trained and tuned model (Operation 1408). It applies the model to this data, generating raw probabilistic outputs for predictions. Inference module 1314 then executes a series of post-processing steps on these outputs, such as converting probabilities to class labels in classification tasks or rescaling values in regression tasks. It contextualizes the outputs as per the application's requirements, handling any uncertainty in predictions and formatting the final outputs for end-user consumption or integration into larger systems.

In an embodiment, the machine learning system 1300 includes a machine learning engine API 1316. The machine learning engine API 1316 allows for applications to leverage machine learning engine 1302. In an embodiment, machine learning engine API 1316 may be built on a RESTful architecture and offer stateless interactions over standard HTTP/HTTPS protocols. Machine learning engine API 1316 may feature a variety of endpoints, each tailored to a specific function within machine learning engine 1302. In an embodiment, endpoints such as /submitData facilitate the submission of new data for processing, while /retrieveResults is designed for fetching the outcomes of data analysis or model predictions. The MLE API may also include endpoints like /updateModel for model modifications and/trainModel to initiate training with new datasets.

In an embodiment, machine learning engine API 1316 is equipped to support SOAP-based interactions. This extension involves defining a WSDL (Web Services Description Language) document that outlines the API's operations and the structure of request and response messages. In an embodiment, machine learning engine API 1316 supports various data formats and communication styles. In an embodiment, machine learning engine API 1316 endpoints may handle requests in JSON format or any other suitable format. For example, machine learning engine API 1316 may process XML, and it may also be engineered to handle more compact and efficient data formats, such as Protocol Buffers or Avro, for use in bandwidth-limited scenarios.

In an embodiment, machine learning engine API 1316 is designed to integrate WebSocket technology for applications necessitating real-time data processing and immediate feedback. This integration enables a continuous, bi-directional communication channel for a dynamic and interactive data exchange between the application and machine learning engine 1302.

### C. Example Generative Models of a Machine Learning System

A generative model is a machine learning model that is capable of generating new data instances based on the data used to train the model. A generative model may be referred to as a “generative artificial intelligence (AI) model.” Generative models learn the underlying distribution of the training data, enabling them to produce new instances of data that share properties with the original dataset. This capability makes them particularly useful in a variety of applications, including image and voice generation, text synthesis, and more sophisticated tasks like unsupervised learning, semi-supervised learning, and domain adaptation.

One type of generative model is a large language model. Large language models are designed to understand, generate, and interpret human language by processing extensive collections of data. The foundational architecture behind large language models is the transformer network, a type of neural network that excels in handling sequential data such as text. Unlike architectures, such as recurrent neural networks (RNNs) or long short-term memory networks (LSTMs), transformers do not process data in order. Instead, they leverage parallel processing to analyze entire text sequences simultaneously, significantly improving efficiency and reducing training times.

In an embodiment, a mechanism that enables transformers to handle complex language tasks is self-attention. This mechanism allows the model to weigh the importance of different words within a sentence or sequence regardless of their position. For instance, in processing the phrase “The cat sat on the mat,” the model can directly associate “cat” with “mat” without having to process the intermediate words sequentially. This ability to understand the context and relationships between words in a sentence is what makes transformer networks adept at language tasks. The self-attention mechanism assigns scores to relationships between words, highlighting the most relevant connections, so the model can focus on the most informative parts of the text.

In accordance with one or more embodiments, transformers are composed of multiple layers containing a multi-head, self-attention mechanism and a position-wise, feed-forward network. Within the architecture of transformer models, the multi-head, self-attention mechanism and position-wise, feed-forward network function in concert to process input data. The multi-head, self-attention mechanism is designed to enable parallel processing of input sequences, allowing the model to simultaneously evaluate the importance of different segments of the input relative to each other. This mechanism operates by generating multiple sets of query, key, and value vectors for each element in the input sequence through linear transformation. The relevance of each element to every other element is calculated using a scaled dot-product attention function that computes the attention scores by taking the dot product of the query vector with the key vectors, dividing each by the square root of the dimension of the key vectors to scale the scores, then applying a softmax function to obtain the weights for the value vectors. The scaled dot-product attention function is applied independently by each head in the multi-head self-attention mechanism. The outputs of these heads are then concatenated and linearly transformed, allowing the model to capture information from different representation subspaces.

In accordance with one or more embodiments, following the multi-head, self-attention mechanism is the position-wise, feed-forward network. This component comprises two linear transformations with a non-linear activation function in between. Each element of the input sequence, now enriched with context by the self-attention mechanism, is processed independently through the same feed-forward network. The first linear transformation increases the dimensionality of the input, allowing for a richer representation space. The non-linear activation function introduces the capability to capture non-linear relationships within the data. The second linear transformation then reduces the dimensionality back to that of the model's hidden layers, preparing the output for either further processing by subsequent layers or final output generation. This sequence of operations is applied to each position in the sequence, so the model can learn complex patterns across different parts of the input data without relying on the sequential processing inherent to previous architectures, such as RNNs or LSTMs.

In accordance with one or more embodiments, integrating these components within the transformer architecture facilitates the model's ability to understand and generate human language by leveraging both the global context provided by the self-attention mechanism and the local, position-specific transformations applied by the feed-forward networks. Through the repetitive stacking of layers, transformers achieve a depth of representation that allows for the processing of linguistic information across varying levels of complexity.

In accordance with one or more embodiments, input/output module 1304, when used for large language models, handles textual data, converting input text into a format that the model can process. This typically involves tokenization, where the text is broken down into manageable pieces, such as words or subwords, and then converted into numerical representations. These representations, or embeddings, capture semantic information about the text that is then fed into the model for processing. The output from the model is converted from numerical form back into human-readable text, following the generation of predictions or responses.

In accordance with one or more embodiments, data preprocessing module 1306 in the context of large language models may include steps such as normalization, where the text is converted to a uniform case and punctuation is standardized. This process ensures that the model treats similar words or symbols consistently, reducing the complexity of the input space. Additionally, techniques such as sentence segmentation may be applied to manage longer texts, enabling the model to process information in chunks that align with natural language structures.

In accordance with one or more embodiments, model selection module 1308, when used for large language models involves choosing a specific architecture and configuration that is best suited to the task at hand. This decision is based on various factors, such as the size of the available training data, the complexity of the language tasks to be performed, and computational resource constraints. Models may vary in size from millions to billions of parameters, with larger models generally capable of more nuanced language understanding and generation but requiring significantly more computational power to train and operate.

In accordance with one or more embodiments, training module 1310, when used for large language models, is configured to adjust the model's parameters through exposure to training data. This process utilizes optimization algorithms, such as stochastic gradient descent, to minimize the difference between the model's predictions and the actual desired outputs. The training process is computationally intensive, often requiring specialized hardware such as GPUs or TPUs to manage the large volumes of data and the complexity of the model calculations. During training, techniques, such as dropout and layer normalization, are used to improve model generalization and prevent overfitting (i.e., when a model learns the detail and noise in the training data to the extent that it negatively impacts the model's performance on new data).

In accordance with one or more embodiments, evaluation and tuning module 1312 assesses the performance of large language models using metrics such as perplexity, accuracy, and F1 score, depending on the specific language tasks. Evaluation may involve comparing the model's output against a set of labeled validation data, providing insight into how well the model has learned to perform tasks, such as text classification, question answering, or text generation. Tuning involves adjusting model parameters or training strategies based on evaluation outcomes to improve performance. This may include hyperparameter tuning, where parameters that govern the training process, such as learning rate or batch size, are adjusted.

In accordance with one or more embodiments, inference module 1314, in the context of large language models, is responsible for generating predictions or responses based on new, unseen data. This process involves feeding the input data through the trained model to produce an output. Inference can be used for a variety of applications, including translating text, generating human-like responses in a chatbot, or summarizing articles.

Another type of generative model is a large multimodal model (LMM). A large multimodal model is an advanced machine learning model capable of processing and generating data across multiple modalities, such as text, images, audio, and video. These models integrate diverse datasets during training to learn the underlying distribution of different data types, enabling them to produce outputs that reflect a comprehensive understanding of the input data. These models can be used for applications such as image captioning, text-to-image generation, image-to-text generation, visual question answering, and more, where understanding the relationship between different data types is crucial. By leveraging diverse datasets during training, large multimodal models learn to create coherent and contextually relevant outputs across various modalities, enhancing their utility in complex, real-world scenarios.

The architecture of large multimodal models combines elements from different neural network designs to handle diverse data types effectively. For example, convolutional neural networks (CNNs) are often used for processing visual data, while transformer networks handle textual data, enabling the model to extract and synthesize features from both images and text. This integration results in outputs that accurately represent the input data, reflecting a deep understanding of both modalities. The transformer architecture, known for its ability to manage sequential data, is frequently adapted to work alongside CNNs, allowing these models to benefit from the strengths of each neural network type.

In at least some instances, the self-attention mechanism, a cornerstone of transformer networks, is integral to the functioning of large multimodal models. It enables the model to weigh the importance of different elements within an input sequence, regardless of their position, allowing it to capture intricate relationships between various data types. For example, in an image captioning task, the model can associate specific visual features with corresponding descriptive text, enhancing the coherence and accuracy of the generated captions. By assigning scores to relationships between elements, the self-attention mechanism highlights the most relevant connections, enabling the model to focus on the most informative parts of the input data and perform complex multimodal tasks effectively.

In large multimodal models, data preprocessing is a step that ensures the input data is in a suitable format for the model to process. This involves tasks such as tokenization for text data, where the text is broken down into manageable pieces, and feature extraction for image data, where key visual elements are identified and encoded. By standardizing and normalizing different data types, preprocessing reduces the complexity of the input space, enabling the model to treat similar elements consistently. Effective preprocessing is essential for the model to integrate information from various modalities and produce accurate, meaningful outputs.

Training large multimodal models involves optimizing their parameters through exposure to diverse datasets that include paired data from different modalities. This computationally intensive process often requires specialized hardware like GPUs or TPUs to manage the large volumes of data and the complexity of the model calculations. Techniques such as dropout and layer normalization are employed to improve model generalization and prevent overfitting. By iteratively adjusting the model's parameters, the training process enables the model to learn underlying patterns and relationships within the data, enhancing its ability to generate coherent and contextually relevant outputs across different modalities.

Evaluation and tuning of large multimodal models are conducted using various metrics tailored to the specific tasks they are designed to perform. For example, BLEU scores are used for text generation tasks, while accuracy is commonly applied for visual recognition tasks to assess performance. Tuning involves adjusting hyperparameters and refining training strategies based on evaluation results to enhance the model's effectiveness. This iterative process ensures that the model can perform a wide range of multimodal tasks with high accuracy and relevance, making it a versatile tool for applications requiring the integration of different types of data.

Large multimodal models represent a significant advancement in machine learning by leveraging sophisticated architectures that combine different neural network types and apply self-attention mechanisms. This enables them to perform complex tasks that require understanding and synthesizing information from diverse data types. Effective preprocessing, rigorous training, and thorough evaluation are crucial to their success, allowing these models to generate coherent and contextually relevant outputs across a wide range of applications.

In accordance with one or more embodiments, other types of models besides large language models and large multimodal models belong to the broad category of generative models. For example, stochastic models directly incorporate randomness into their structure, making them inherently generative as they can produce a diverse set of outputs for a given input. Generative Adversarial Networks (GANs) learn to generate new data that is indistinguishable from the data they were trained on, using a dual-network architecture that involves a generative component. Variational Autoencoders (VAEs) are explicitly designed for generating new data points by learning a distribution of the input data and encode inputs into a latent space and generate outputs by sampling from this space, making them inherently generative. Sequence-to-sequence models are generative in nature when used with sampling strategies. Although this list of generative model types is not exhaustive, it illustrates the broad use of the term generative model beyond large language models.

Although generative models can be leveraged for classification tasks, they inherently operate on principles of randomness, leading to a spectrum of possible outcomes in response to identical inputs. Unlike deterministic models that yield a consistent result whenever the same input is given, generative models use the randomness in the data they are trained on to both mimic and diversify from the training data. This diversity makes generative models ideal for generating new and varied data points as well as for tasks that require creativity and novelty. However, a reliance on randomness creates a trade-off between predictability and flexibility for generative models, potentially making them less predictable in scenarios where uniform outcomes may be expected such as classification tasks.

### 8. Hardware System

According to one embodiment, the techniques described herein are implemented by one or more special-purpose computing devices. The special-purpose computing devices may be hard-wired to perform the techniques or may include digital electronic devices, such as one or more application-specific integrated circuits (ASICs), field programmable gate arrays (FPGAs), or network processing units (NPUs) that are persistently programmed to perform the techniques. Also, the special-purpose computing devices may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices, or any other device that incorporates hard-wired and/or program logic to implement the techniques.

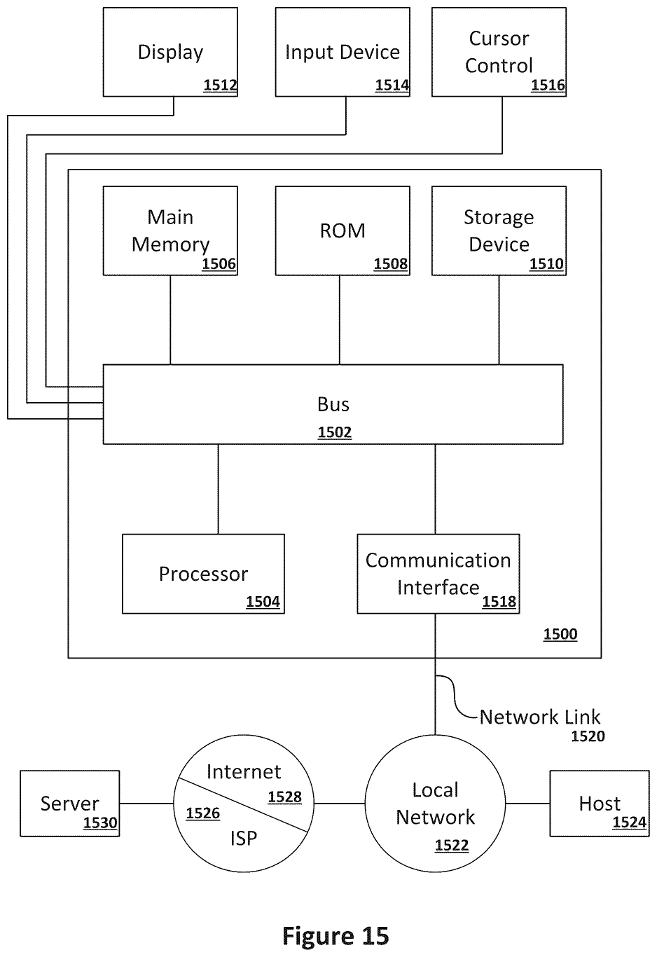

For example, FIG. 15 is a block diagram that illustrates a computer system 1500 upon which an embodiment of the disclosure may be implemented. Computer system 1500 includes a bus 1502 or other communication mechanism for communicating information, and a hardware processor 1504 coupled with bus 1502 for processing information. Hardware processor 1504 may be, for example, a general-purpose microprocessor.

Computer system 1500 also includes a main memory 1506, such as a random-access memory (RAM) or other dynamic storage device, coupled to bus 1502 for storing information and instructions to be executed by processor 1504. Main memory 1506 also may be used for storing temporary variables or other intermediate information during execution of instructions to be executed by processor 1504. Such instructions, when stored in non-transitory storage media accessible to processor 1504, render computer system 1500 into a special-purpose machine that is customized to perform the operations specified in the instructions.

Computer system 1500 further includes a read only memory (ROM) 1508 or other static storage device coupled to bus 1502 for storing static information and instructions for processor 1504. A storage device 1510, such as a magnetic disk, optical disk, or a Solid-State Drive (SSD) is provided and coupled to bus 1502 for storing information and instructions.

Computer system 1500 may be coupled via bus 1502 to a display 1512, such as a cathode ray tube (CRT), for displaying information to a computer user. An input device 1514, including alphanumeric and other keys, is coupled to bus 1502 for communicating information and command selections to processor 1504. Another type of user input device is cursor control 1516, such as a mouse, a trackball, or cursor direction keys for communicating direction information and command selections to processor 1504 and for controlling cursor movement on display 1512. This input device typically has two degrees of freedom in two axes, a first axis (e.g., x) and a second axis (e.g., y), that allows the device to specify positions in a plane.

Computer system 1500 may implement the techniques described herein using customized hard-wired logic, one or more ASICs or FPGAs, firmware, and/or program logic that in combination with the computer system causes or programs computer system 1500 to be a special-purpose machine. According to one embodiment, the techniques herein are performed by computer system 1500 in response to processor 1504 executing one or more sequences of one or more instructions contained in main memory 1506. Such instructions may be read into main memory 1506 from another storage medium, such as storage device 1510. Execution of the sequences of instructions contained in main memory 1506 causes processor 1504 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 1510. Volatile media includes dynamic memory, such as main memory 1506. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 1502. Transmission media can also take the form of acoustic or light waves, such as those generated during radio-wave and infra-red data communications.

Various forms of media may be involved in carrying one or more sequences of one or more instructions to processor 1504 for execution. For example, the instructions may initially be carried on a magnetic disk or solid-state drive of a remote computer. The remote computer can load the instructions into its dynamic memory and send the instructions over a telephone line using a modem. A modem local to computer system 1500 can receive the data on the telephone line and use an infra-red transmitter to convert the data to an infra-red signal. An infra-red detector can receive the data carried in the infra-red signal and appropriate circuitry can place the data on bus 1502. Bus 1502 carries the data to main memory 1506, from which processor 1504 retrieves and executes the instructions. The instructions received by main memory 1506 may optionally be stored on storage device 1510 either before or after execution by processor 1504.

Computer system 1500 also includes a communication interface 1518 coupled to bus 1502. Communication interface 1518 provides a two-way data communication coupling to a network link 1520 that is connected to a local network 1522. For example, communication interface 1518 may be an integrated services digital network (ISDN) card, cable modem, satellite modem, or a modem to provide a data communication connection to a corresponding type of telephone line. As another example, communication interface 1518 may be a local area network (LAN) card to provide a data communication connection to a compatible LAN. Wireless links may also be implemented. In any such implementation, communication interface 1518 sends and receives electrical, electromagnetic, or optical signals that carry digital data streams representing various types of information.

Network link 1520 typically provides data communication through one or more networks to other data devices. For example, network link 1520 may provide a connection through local network 1522 to a host computer 1524 or to data equipment operated by an Internet Service Provider (ISP) 1526. ISP 1526 in turn provides data communication services through the worldwide packet data communication network now commonly referred to as the “Internet” 1528. Local network 1522 and Internet 1528 both use electrical, electromagnetic, or optical signals that carry digital data streams. The signals through the various networks and the signals on network link 1520 and through communication interface 1518, that carry the digital data to and from computer system 1500, are example forms of transmission media.

Computer system 1500 can send messages and receive data, including program code, through the network(s), network link 1520 and communication interface 1518. In the Internet example, a server 1530 might transmit a requested code for an application program through Internet 1528, ISP 1526, local network 1522 and communication interface 1518.

The received code may be executed by processor 1504 as it is received, and/or stored in storage device 1510, or other non-volatile storage for later execution.

### 9. Miscellaneous; Extensions

Embodiments are directed to a system with one or more devices that include a hardware processor and that are configured to perform any of the operations described herein and/or recited in any of the claims below. Embodiments are directed to a system that includes means to perform any of the operations described herein and/or recited in any of the claims below. In an embodiment, a non-transitory, computer-readable storage medium comprises instructions that, when executed by one or more hardware processors, causes performance of any of the operations described herein and/or recited in any of the claims.

Any combination of the features and functionalities described herein may be used in accordance with one or more embodiments. In the foregoing specification, embodiments have been described with reference to numerous specific details that may vary from implementation to implementation. Accordingly, the specification and drawings are to be regarded in an illustrative rather than a restrictive sense. The sole and exclusive indicator of the scope of patent protection, and what is intended by the applicants to be the scope of patent protection, is the literal and equivalent scope of the set of claims that issue from this application in the specific form that such claims issue, including any subsequent correction.

References, including publications, patent applications, and patents, cited herein are hereby incorporated by reference to the same extent as if the references were individually and specifically indicated to be incorporated by reference and were set forth in entirety herein.

What is claimed is:

1. A method, comprising:
obtaining telemetry data associated with a fabric organized according to a fabric topology, wherein the fabric comprises a set of interconnected switches that provide multiple redundant pathways for routing network traffic between computing devices linked to the fabric;
identifying, based at least on the fabric topology, a first portion of the telemetry data corresponding to a first subsection of the fabric;
determining, based at least on the fabric topology and the first portion of the telemetry data, a first performance metric corresponding to the first subsection of the fabric;
based at least on the first performance metric, steering at least a portion of network traffic from the first subsection of the fabric to a second subsection of the fabric;
wherein the method is performed by at least one device including a hardware processor.

2. The method of claim 1, wherein determining the first performance metric corresponding to the first subsection of the fabric comprises:
determining a quantity of a set of active pathways between a first switch and a second switch of the first subsection of the fabric;
determining a capacity of the set of active pathways;
determining the first performance metric based at least in part on the capacity of the set of active pathways.

3. The method of claim 2, wherein determining the quantity of the set of active pathways comprises:
identifying a set of pathways between the first switch based on the fabric topology;
identifying an operating state for particular pathways of the set of pathways based on the telemetry data, wherein the operation state comprises one of: active or inactive;
counting the quantity of the particular pathways that comprise the operating state of active;
designating the quantity of the particular pathways that comprise the operating state of active as the quantity of the set of active pathways.

4. The method of claim 3, wherein one or more particular pathways of the set of pathways comprise the operating state of inactive, and wherein determining the quantity of the set of active pathways comprises:
excluding, from the set of active pathways, the one or more particular pathways that comprise the operating state of inactive.

5. The method of claim 1, wherein steering at least a portion of network traffic from the first subsection of the fabric to the second subsection of the fabric comprises:
modifying a routing configuration for at least a portion of the fabric.

6. The method of claim 5, wherein:
based on modifying the routing configuration, a first portion of the network traffic is routed across the second subsection of the fabric, and
without modifying the routing configuration, the first portion of the network traffic would be routed across the first subsection of the fabric.

7. The method of claim 1, wherein steering at least a portion of network traffic from the first subsection of the fabric to the second subsection of the fabric comprises:
modifying a routing protocol executable by one or more switches of the set of interconnected switches to route network traffic across at least a portion of the fabric;
wherein based on modifying the routing protocol, execution of the routing protocol produces at least one of: a decrease in network traffic across the first subsection of the fabric attributable to modifying the routing protocol, or an increase in network traffic across the second subsection of the fabric attributable to modifying the routing protocol.

8. The method of claim 1, further comprising:
identifying, based at least on the fabric topology, a second portion of the telemetry data corresponding to the second subsection of the fabric;
determining, based at least on the fabric topology and the second portion of the telemetry data, a second performance metric corresponding to the second subsection of the fabric;
wherein steering at least the portion of the network traffic from the first subsection of the fabric to the second subsection of the fabric is further based on the second performance metric.

9. The method of claim 8,
wherein the first performance metric comprises a first capacity of the first subsection of the fabric;
wherein the second performance metric comprises a second capacity of the second subsection of the fabric.

10. The method of claim 1, wherein the first subsection of the fabric comprises a first set of switches, and wherein the first portion of the telemetry data is indicative of the first set of switches being out of service, and wherein the first performance metric is attributable at least in part to the first set of switches being out of service.

11. The method of claim 1, further comprising:
determining that the first performance metric meets a threshold;
steering at least the portion of network traffic from the second subsection of the fabric to the first subsection of the fabric based at least on determining that the first performance metric meets a threshold.

12. The method of claim 11, further comprising:
determining, based on the telemetry data, a utilization metric associated with at least the first subsection of the fabric;
determining a headroom of at least the first subsection of the fabric based on the utilization metric;
wherein determining that the first performance metric satisfies the threshold comprises determining that the headroom satisfies the threshold.

13. The method of claim 11, further comprising:
determining a priority level for data routing between the set of computing devices linked to the fabric;
determining the threshold based at least on the priority level.

14. The method of claim 1,
wherein the first subsection of the fabric comprises a first set of leaf switches connected to a first set of computing devices and wherein a second subsection of the fabric comprises a second set of leaf switches connected to the first set of computing devices,
wherein steering network traffic from the first subsection of the fabric to the second subsection of the fabric comprises preferentially routing network traffic to the first set of computing devices via the second set of leaf switches relative to the first set of leaf switches.

15. The method of claim 1,
wherein the first subsection of the fabric comprises a first set of spine switches connected to a set of leaf switches and wherein a second subsection of the fabric comprises a second set of spine switches connected to the set of leaf switches,
wherein steering network traffic from the first subsection of the fabric to the second subsection of the fabric comprises preferentially routing network traffic to the set of leaf switches via the second set of spine switches relative to the first set of spine switches.

16. The method of claim 1,
wherein the first subsection of the fabric comprises a first set of switches connected to a first set of computing devices and wherein a second subsection of the fabric comprises a second set of switches connected to a second set of computing devices,
wherein steering network traffic from the first subsection of the fabric to the second subsection of the fabric comprises preferentially routing network traffic to the second set of computing devices via the second set of switches relative to routing network traffic to the first set of computing devices via the first set of switches.

17. The method of claim 1,
wherein the first subsection of the fabric comprises a first set of switches and the second subsection of the fabric comprises a second set of switches,
wherein steering network traffic from the first subsection of the fabric to the second subsection of the fabric comprises:
modifying a routing protocol executable by one or more switches of the set of interconnected switches,
wherein, based on modifying the routing protocol, the one or more switches preferentially route network traffic across the second subsection of the fabric by directing at least some of the network traffic to the second set of switches in lieu of the first set of switches.

18. The method of claim 1, wherein steering network traffic from the first subsection of the fabric to the second subsection of the fabric comprises:
modifying a routing parameter utilized in a path selection protocol, the path selection protocol being executable by a first switch of the set of interconnected switches to select target destinations for routing network traffic from the first switch along a set of available paths, wherein the first subsection of the fabric comprises a first target destination on a first path from the first switch to a first computing device of the set of computing devices;
wherein, based on modifying the routing parameter, the path selection protocol, when executed by the first switch, preferentially returns the first target destination for selection by the first switch over a second target destination on a second path from the first switch to the first computing device.

19. The method of claim 1, wherein the fabric comprises a remote direct memory access fabric (RDMA) fabric, and wherein steering network traffic from the first subsection of the fabric to the second subsection of the fabric comprises:
increasing network traffic between a first computing device and a second computing device linked to the RDMA fabric.

20. One or more non-transitory computer-readable media comprising instructions that, when executed by one or more hardware processors, cause performance of operations comprising:
obtaining telemetry data associated with a fabric organized according to a fabric topology, wherein the fabric comprises a set of interconnected switches that provide multiple redundant pathways for routing network traffic between computing devices linked to the fabric;
identifying, based at least on the fabric topology, a first portion of the telemetry data corresponding to a first subsection of the fabric and a second portion of the telemetry data corresponding to a second subsection of the fabric;
determining, based at least on the fabric topology and the first portion of the telemetry data, a first performance metric corresponding to the first subsection of the fabric;
based at least on the first performance metric, steering at least a portion of network traffic from the first subsection of the fabric to the second subsection of the fabric.

21. A system comprising:
at least one device including a hardware processor;
the system being configured to perform operations comprising:
obtaining telemetry data associated with a fabric organized according to a fabric topology, wherein the fabric comprises a set of interconnected switches that provide multiple redundant pathways for routing network traffic between computing devices linked to the fabric;
identifying, based at least on the fabric topology, a first portion of the telemetry data corresponding to a first subsection of the fabric and a second portion of the telemetry data corresponding to a second subsection of the fabric;
determining, based at least on the fabric topology and the first portion of the telemetry data, a first performance metric corresponding to the first subsection of the fabric;
based at least on the first performance metric, steering at least a portion of network traffic from the first subsection of the fabric to the second subsection of the fabric.
